(19) United States
(12) Patent Application Publication
(10) Pub. No.: US 2023/0368675 A1
(43) Pub. Date: Nov. 16, 2023

(54) Systems and Methods for Traffic Management in Interactive Vehicle Transport Networks

(71) Applicant: I R Kinetics Limited, Accrington (GB)

(72) Inventors: David Gardner, Accrington (GB); Andrew Bradley, Accrington (GB)

(21) Appl. No.: 18/030,058

(22) PCT Filed: Oct. 11, 2021
(86) PCT No.: PCT/GB2021/052625

§ 371 Date: Apr. 3, 2023

(30) Foreign Application Priority Data
Oct. 9, 2020 (GB) 2016103.0

(51) Int. Cl. G08G 1/00; G08G 1/16; G08G 1/01; B60W 60/00; B60W 30/18; B60W 30/16; B60L 53/36; B60L 53/12; B60L 53/14; B60L 53/38; B60W 30/095; B60W 30/09

(52) U.S. Cl. CPC G08G 1/22; B60L 53/12; B60L 53/14; B60L 53/36; B60L 53/38; B60W 30/09; B60W 30/0956; B60W 30/16; B60W 30/18172; B60W 60/0015; G08G 1/0133; G08G 1/167; B60W 2554/80

(57) ABSTRACT

The present invention concerns a vehicle management system for controlling movement of a plurality of vehicles along a pathway at a current geographic location of a transport network, the vehicle management system comprising: a receiver configured to: receive sensed kinematic parameters of the plurality of vehicles at the current geographic location; and receive event data relating to the occurrence of an event concerning the movement of the plurality of vehicles, a processor configured to: determine required kinematic parameters of at least one of the plurality of vehicles in order to respond to the event; determine, based on the sensed kinematic parameters and the required kinematic parameters, one or more actions to be taken by the one or more of the plurality of vehicles which enable the required kinematic parameters to be achieved; and generate one or more instruction signals for the one or more vehicles to instruct the one or more actions to be taken; and a transmitter configured to transmit the one or more instruction signals to the respective one or more vehicles to enable the one or more actions to be implemented.

### FIELD OF THE INVENTION

The present invention is concerned with systems and methods for interactive vehicle transport networks, such as those involving autonomous vehicles. More particularly, though not exclusively, the present invention is directed to improvements in or relating to systems and methods for the operation of transport networks involving ground-based, airborne or floating vehicles providing transportation of passengers or goods within cities, urban areas or along, above or near designated motorways, freeways, roads, railways, waterways or other routes between cities and urban areas. Any or all of the vehicles may be anywhere on the scale from fully autonomous to fully driver/pilot controlled. Also, they may or may not be linked to local, regional, or national traffic management systems.

### BACKGROUND OF THE INVENTION

With ongoing developments in autonomous vehicle operation, there exists a need to adapt traffic management systems to take advantage of the new capabilities of autonomous vehicles. In particular, as vehicles are increasingly capable of regulating their own movement, some of the disadvantages of user operation are removed, such as a driver or pilot’s reaction speeds, concentration levels, tiredness etc. As a result, autonomous vehicles or semi-autonomous vehicles operating in an autonomous mode (both referred to as autonomous vehicles hereinafter), are more able to react quickly to traffic events or environmental hazards and as a result, higher speeds and higher densities of vehicles are able to be safely achieved than when compared to user operated vehicles, where factors such as thinking distance must be applied when considering safe stopping distances.

As traffic networks become increasingly complex, it becomes ever more important that traffic management systems are able to account for changes in the expected behaviour of autonomous vehicles in a quick and safe manner. For example, if a user of an autonomous vehicle in a traffic network decides to alter their route or intended destination such that the vehicle is now required to leave the traffic network (for example by using a motorway exit) at a different location to the previously expected location, the traffic management system must be able to account for this in order to enable the vehicle to leave safely. Similarly, if an unexpected event such as a crash occurs, the traffic management system must be able to account for this as well in order to ensure vehicles in the vicinity of the event site are able to safely continue their journey. At high speeds in densely populated traffic networks, the complexity of such management increases.

Presently known systems in this field are predicated on the overall engineering architecture concept that each vehicle independently maintains its own situational awareness and communicates its presence, trajectory and intentions to other vehicles in its locality, possibly receiving the corresponding information from vehicles in its locality and then each vehicle acts independently in order to make and enact its own decisions.

The complexity and limitations of these types of independent approaches have significant drawbacks in their implementation. The independent nature of the actions which are enacted actually increase safety hazard risks. In addition, they are extremely difficult to regulate and in the absence of mandatory engineering standards provide no viable route for manufacturers around the world to create autonomous or semi-autonomous vehicles that can interoperate cooperatively and safely, particularly in complex decision making and enactment locations such as those covered by these embodiments. Furthermore, these types of approaches do not enable control of the manoeuvres of the hundreds of vehicles involved at locations such as motorway junctions by coordinating them efficiently and safely.

For example, for vehicles to exit a stream of fast-moving traffic approaching a junction on a three lane highway / freeway / motorway, decisions need to be made, plans formulated and manoeuvres initiated (either in the mind of the user/driver or the computer system of the vehicle) a significant distance (typically a mile) in advance of the junction and a strategy based on vehicles transmitting their presence and intentions to other vehicles in their local vicinity just cannot achieve this. As another example, if there are conductive or inductive power transfer systems for electrically powered vehicles provided in, say, one of the lanes in a specific stretch of a multi-lane carriageway then those vehicles requiring power or charge will need to be prioritized and selected to use the charging lane and the necessary decisions and manoeuvres made over similar distances.

Despite the huge investments made by a number of large technology companies in driverless cars the past decade has shown extremely slow progress, with safety hazard risks becoming increasingly of concern to the extent that the potential for regulatory approval of driverless vehicles is brought into question. These embodiments seek to extend the progress made towards improved journey times and safer motorways/highways achieved by Smart Motorways and similar Traffic Advisory Systems (TASs) for driven vehicles (both ground-based and airborne) and developing them into localised, co-operative networks of tracking apparatuses that can supplement the features of autonomous and semi-autonomous vehicles to achieve the desired increases in efficiency, safety and infrastructure maintainability and a transition to electric power with the option of adaptive infrastructure tolling for road, air and water transport networks.

It is an object of the present invention to address at least one or more of the problems described above.

### SUMMARY OF THE DISCLOSURE

According to a first aspect of the present embodiments, there is provided a vehicle management system for controlling movement of a plurality of vehicles along a pathway at a current geographic location of a transport network. The vehicle management system comprises a receiver, a processor and a transmitter. The received is configured to receive sensed kinematic parameters of the plurality of vehicles at the current geographic location, and receive event data relating to the occurrence of an event concerning the movement of the plurality of vehicles. The processor is configured to determine required kinematic parameters of at least one of the plurality of vehicles in order to respond to the event, determine, based on the sensed kinematic parameters and the required kinematic parameters, one or more actions to be taken by the one or more of the plurality of vehicles which enable the required kinematic parameters to be achieved, and generate one or more instruction signals for the one or more vehicles to instruct the one or more actions to be taken. Finally, the transmitter is configured to transmit the one or more instruction signals to the respective one or more vehicles to enable the one or more actions to be implemented.

In some embodiments, the event data comprises a manoeuvre request from a vehicle, a threshold for a vehicle movement parameter (for example traffic density), or an alert regarding an emergency event. In such embodiments, the processor may be configured to determine a current position of an event-related vehicle. Further, the processor may be configured to generate actions to increase the speed of a vehicle of the plurality of vehicles which is downstream of the current position of the event-related vehicle to create a gap between adjacent vehicles of the plurality of vehicles. The processor may also be configured to generate actions to decrease the speed of a vehicle of the plurality of vehicles which is upstream of the current position of the event-related vehicle to create a gap between adjacent vehicles of the plurality of vehicles. Where a gap is created, the processor may be configured to generate an action to move the event-related vehicle into the gap. The processor may be configured to generate one or more actions to regularise separations between adjacent vehicles of the plurality of vehicles following movement of the event-related vehicle into the gap.

In some relevant embodiments, the pathway comprises a plurality of lanes and the processor is configured to generate actions to create a gap in an adjacent lane to a current lane of the event-related vehicle or hazard by decreasing the speed of a vehicle of the plurality of vehicles which is upstream of the current position of the event-related vehicle or hazard and/or increasing the speed of a vehicle of the plurality of vehicles which is downstream of the current position of the event-related vehicle or hazard, and move a vehicle of the plurality of vehicles, upstream of and in the same lane as the event-related vehicle or hazard, into the gap. In such embodiments, the processor may be configured to move a vehicle downstream of and in an adjacent lane as the event-related vehicle or hazard into the same lane as the event-related vehicle or hazard.

In some embodiments, the processor is configured to generate actions to alter the speed of a vehicle of the plurality of vehicles to minimise a distance between adjacent vehicles to a predetermined minimum thereby increasing a traffic density parameter.

In further embodiments, the processor is configured to generate actions to move a vehicle of the plurality of vehicles to a location within the pathway aligned with inductive or conductive charging apparatus and to maintain the alignment of the vehicle with the inductive or conductive charging apparatus for a period of time to enable inductive or conductive charging of the vehicle to be carried out whilst the vehicle is moving along the pathway.

The processor may be configured to generate actions to maintain a docking vehicle of the plurality of vehicles at a constant speed and a constant location relative to the pathway, and guide another vehicle to dock with the docking vehicle whilst the docking vehicle is moving along the pathway.

In some embodiments, the receiver is configured to receive incident data from a vehicle of the plurality of vehicles, the incident data relating to a geographic location of an incident sensed by the vehicle, and the processor is configured to store the geographic location of the incident in a data store. In these embodiments, the transmitter may be configured to transmit the incident data to an infrastructure monitoring system. The incident data may relate to the physical condition of the pathway sensed by the vehicle at a plurality of specific geographical locations.

In further embodiments, the receiver is configured to receive further sensed parameters from another system communicatively coupled to the vehicle management system and the processor is configured to determine the required parameters from the further sensed parameters. In such embodiments, the further sensed parameters may relate to an event occurring at a location towards which the plurality of vehicles is travelling, downstream of the current geographic location. The further sensed parameters may relate to a desired traffic density or flow rate event.

In yet further embodiments, the receiver is configured to receive the sensed kinematic parameters from one or more vehicle tracking/monitoring apparatus provided about the pathway.

In some embodiments of the present aspect, the transmitter is configured to transmit the one or more instruction signals to the one or more of the plurality of vehicles via one or more vehicle tracking/monitoring apparatus provided about the pathway.

In some embodiments of the present aspect, one of the plurality of vehicles comprises an autonomous or semi-autonomous vehicle and the instruction signal comprises a control signal configured to control the movement of the autonomous or semi-autonomous vehicle.

The vehicle management system may further comprise one or more vehicle tracking apparatus provided about the pathway at the geographical location, the vehicle tracking apparatus having a positional measurement accuracy to within 10 cm with a dynamic latency of less than 20 milliseconds. In such embodiments, the one or more vehicle tracking apparatus may have a field of view directed to the pathway and may be configured to sense the position of each of the plurality of vehicles and may determine the sensed kinematic data from the sensed positions over a time period. In such embodiments, the one or more vehicle tracking apparatus may comprise a plurality of vehicle tracking apparatuses communicatively connected together in a local area network configuration. The one or more vehicle tracking apparatuses may comprise an infra-red radiation sensor and may also further comprise an infra-red radiation emitter. In relevant embodiments, the one or more vehicle tracking apparatus may be configured to provide the one or more instruction signals to the one or more of the plurality of vehicles. Further, the one or more vehicle tracking apparatus may be configured to track the movement of one or more airborne, waterborne or land vehicles.

In some embodiments of the present aspect, the processor includes an event recognition engine for determining the type of event which the event data relates to and one or more event response processing engines for determining the one or more actions to be taken. In such embodiments, the one or more event processing engines may comprise a lane change request processing engine which is configured to generate actions to enable a requesting vehicle of the plurality of vehicles in a current lane of a multi-lane pathway to move into a different, desired lane of the multi-lane pathway, the lane change processing engine may be configured to determine a current position of the requesting vehicle requesting a change to the desired lane of the multi-lane pathway, generate actions to increase the speed of a vehicle of the plurality of vehicles in the desired lane which is downstream of the current position of the requesting vehicle and/or decrease the speed of a vehicle of the plurality of vehicles in the desired lane which is upstream of the current position of the requesting vehicle, to enable a gap to be created within the desired lane between adjacent moving vehicles of the plurality of vehicles, and to generate an action to move the requesting vehicle into the gap.

In embodiments in accordance with the above, the one or more event processing engines may comprise an exit/entry request processing engine which is configured to generate actions to enable a requesting vehicle of the plurality of vehicles to move from a current lane of the pathway to an exit lane, the exit/entry request processing engine being configured to determine a current position of the requesting vehicle, generate an action to increase the speed of a vehicle of the plurality of vehicles in the exit lane which is downstream of the current position of the requesting vehicle and/or decrease the speed of a vehicle of the plurality of vehicles in the exit lane which is upstream of the current position of the requesting vehicle, to enable a gap to be created within the exit lane between adjacent vehicles of the plurality of vehicles in the exit lane, and generate an action to move the requesting vehicle into the gap.

In relevant embodiments, the one or more event processing engines may comprise an exit/entry request processing engine which is configured to generate actions to enable a requesting vehicle of the plurality of vehicles to move from an entry lane of the pathway into a desired lane, the exit/entry request processing engine being configured to determine a current position of a requesting vehicle requesting a change from an entry lane into the desired lane of a multi-lane pathway, generate actions to increase the speed of a vehicle of the plurality of vehicles in the desired lane which is downstream of the current position of the requesting vehicle and/or decrease the speed of a vehicle of the plurality of vehicles which is upstream of the current position of the requesting vehicle, to enable a gap to be created within the desired lane between adjacent vehicles of the plurality of vehicles, and generate an action to move the requesting vehicle into the gap.

In relevant embodiments, the pathway may comprise a multi-lane pathway and the exit/entry request processing engine is configured to generate actions to enable the requesting vehicle of the plurality of vehicles to move across a lane of the multi-lane pathway which is adjacent to the current lane by increasing the speed of a vehicle of the plurality of vehicles in the adjacent lane which is downstream of the current position of the requesting vehicle and/or decrease the speed of a vehicle of the plurality of vehicles which is upstream of the current position of the requesting vehicle, to enable an adjacent lane gap to be created within the adjacent lane between adjacent moving vehicles of the plurality of vehicles, and move the requesting vehicle into the adjacent lane gap.

The one or more event processing engines may comprise an obstruction/hazard detection processing engine which is configured to identify a location of obstruction/hazard in the pathway; and the obstruction/hazard detection processing engine comprises an exclusion zone generator configured to determine a strategy to enable a vehicle upstream of the location of the obstruction/ hazard to avoid the obstruction/hazard and to generate one or more actions to execute the strategy. In such embodiments, the exclusion zone generator may be configured to generate actions to create a gap in an adjacent lane by reducing the sped of a vehicle upstream of the location of the obstruction / hazard and move a vehicle in the same lane as the obstruction / hazard into the gap in the adjacent lane, thereby creating a virtual island around the obstruction / hazard.

In some embodiments, the one or more event processing engines comprises a traffic density/flow rate management engine which is configured to increase a traffic density/flow rate parameter of the plurality of vehicles by generating actions to alter the speed of one or more vehicles of the plurality of vehicles to minimise a distance between adjacent vehicles to a predetermined minimum.

In a further aspect of the present embodiments, there is provided a method of controlling movement of a plurality of vehicles along a pathway at a current geographic location of a transport network, the method comprising receiving sensed kinematic parameters of the plurality of vehicles at the current geographic location, receiving event data relating to the occurrence of an event concerning the movement of the plurality of vehicles, determining required kinematic parameters of at least one of the plurality of vehicles in order to respond to the event, determining, based on the sensed kinematic parameters and the required kinematic parameters, one or more actions to be taken by the one or more of the plurality of vehicles which enable the required kinematic parameters to be achieved, generating one or more instruction signals for the one or more vehicles to instruct the one or more actions to be taken, and transmitting the one or more instruction signals to the respective one or more vehicles to enable the one or more actions to be implemented. It is to be appreciated that where applicable, this aspect of the invention may be combined with any of the modifications described above with respect to the first aspect of the invention.

In a third aspect of the present embodiments, there is provided a computer-readable storage medium comprising instructions which, when executed by a computer, cause the computer to carry out the steps of the method of the second aspect of the present embodiments. It is to be appreciated that where applicable, this aspect of the embodiments may be combined with any of the modifications described above with respect to the first and second aspects of the embodiments.

### BRIEF DESCRIPTION OF THE DRAWINGS

In order that the disclosure may be more readily understood, reference will now be made, by way of example, to the accompanying drawings in which:

FIG. 1 is a diagram showing an isometric view of a system layout provided by the present embodiments for the management of ground-based traffic at an exit junction on a typical highway / motorway / freeway;

FIG. 2A is a complementary diagrammatic representation of the network of tracking apparatuses, LAN control apparatus (which may also be a tracking apparatus), regional and national TMSs, and main communication paths associated with the system of FIG. 1;

FIG. 2B is a schematic block diagram showing the composition of the LAN control apparatus of FIG. 2;

FIG. 2C is a schematic block diagram showing the composition of the processor shown in FIG. 2A;

FIG. 3A is a flow chart describing an example of the functioning of the system of FIG. 1;

FIG. 3B is a flow chart showing a detailed example of Step 304 of FIG. 3A;

FIG. 4 is a diagram showing an isometric view of a system layout of the system of FIG. 1 for the management of ground-based traffic at an entry junction on a typical highway / motorway / freeway;

FIG. 5 is a diagram showing an isometric view of the system of FIG. 1 at the entry point to the system and at an intermediate point of time in the future when some vehicles are equipped to be tracked and some are not.

FIG. 6 is a diagram showing an isometric view of a system layout of the system of FIG. 1 for the situation where a vehicle breakdown has occurred in two potential locations on a typical highway / motorway / freeway;

FIG. 7A is a flow chart describing a further example of the functioning of the system of FIG. 1;

FIG. 7B is a flow chart showing a detailed example of Step 724 of FIG. 7A;

FIG. 8 is a diagram showing an isometric view of a system layout of the system of FIG. 1 as deployed in a 3-lane carriageway on a highway / motorway / freeway where the left-hand lane is fitted with an inductive electrical charging system in the form of coils under/on the surface and compatible vehicles can receive electrical energy whilst in motion; and

FIG. 9 is a diagram showing an isometric view of a system layout of the system of FIG. 1 as deployed in a 3-lane carriageway on a highway / motorway / freeway on which a vehicle senses a pothole and transmits data on its location to the tracking equipment and possibly on to a wide area infrastructure monitoring system.

### DETAILED DESCRIPTION

Specific embodiments are now described with reference to the appended figures.

It is to be appreciated that references made herein to a vehicle to be tracked may refer to a variety of mobile mechanical objects, including objects which travel along the ground, over water, and in the air. By way of a non-exhaustive list, these vehicles may include cars, lorries, motorcycles, boats, ships, drones, and small aircraft. These vehicles may additionally be configured to be operated manually by a user, either present in the vehicle or remotely located and connected, or the vehicles may be configured to be autonomous, or a combination of the two, namely semi-autonomous.

According to this disclosure, there is provided a method of handling a flow of vehicles along a pathway (including possibly a network of interconnected pathways), the method comprising: tracking the relative locations of a plurality of moving vehicles along the pathway at a plurality of geographic locations; receiving notification of the occurrence of a handling event which requires a change in the relative position of at least one vehicle comprising a subset of the plurality of moving vehicles; determining the new relative position of the at least one moving vehicle of the subset to enable accommodation of the handling event; and transmitting data relating to the new relative position of the at least one vehicle of the subset to the at least one vehicle of the subset such that the at least one vehicle of the subset can manoeuvre into the new relative position to accommodate the handling event.

Preferably, the receiving step comprises receiving notification of the occurrence of a handling event which requires a change in the relative positions of a plurality of vehicles comprising a subset of the plurality of moving vehicles; the determining step comprises determining the new relative positions of the plurality of moving vehicles of the subset to enable accommodation of the handling event; and the transmitting step comprises transmitting data relating to the new relative positions of the plurality of vehicles of the subset to the vehicles of the subset such that the plurality of vehicles of the subset can manoeuvre into the new relative positions to accommodate the handling event.

It is to be appreciated that the term ‘relative location’ is considered to be with respect to the position of one or more other vehicles in some embodiments. In other embodiments, the term ‘relative location’ is considered to be in relation to infrastructure which is provided about the pathway. The infrastructure can relate to a vehicle tracking system and its apparatus or a moving vehicle charging system and its apparatus or an infrastructure monitoring system and its apparatus which is provided about the pathway.

As will be seen from the description of the embodiments provided later, the pathway may comprise multiple lanes possibly linked by intersections, junctions, holding patterns, etc, either on the ground, in water or in the air, each lane accommodating a plurality of vehicles and the handling event comprises a vehicle changing from one lane to another lane or being routed within a network. In addition, any suitable tracking system may be used so long as it determines the positions or kinematic data of the one or more vehicles to a reasonable level of accuracy, for example to the accuracy levels described herein.

The term ‘lane’ is intended to signify a portion of a pathway along which vehicles are guided. Such guidance may be as a result of physical markings/markers/reflectors/emitters provided which can be sensed by the user/driver or by the vehicle itself. Such markings/markers can also be created by providing specific signals at different locations within the pathway such as would for example be used for aircraft to distinguish between different altitudes. Such markings/markers can also be created by the vehicle determining its own position with the required accuracy and with reference to a predetermined map or computer model of the pathway. The use of lanes permits an increased traffic density to be realised as it enables a greater number of vehicles to move in close proximity in a safe manner.

As will be seen from the description of the embodiments provided later, the determining step may comprise determining positions of at least some of the vehicles of the subset at a location earlier (upstream) along the flow of traffic than at a location of the handling event, which are required to create a gap between vehicles, and determining positions of other vehicles of the subset at the location of the handling event to enable at least one vehicle to move into the gap. In this regard the term ‘upstream’ is a relative term in a flow of vehicles which indicates that a region in which one or more vehicles are located in advance of reaching a current position. Similarly, the term ‘downstream’ is a relative term in a flow of vehicles which indicates a region in which one or more vehicles are located after a current position typically having passed through the current position.

The present embodiments are concerned with improvements in or relating to systems and methods for the operation of “Interactive Transport Networks” involving ground based, water-borne or airborne vehicles providing transportation of passengers or goods within cities, urban areas or along or above designated motorways, freeways, roads, railways, air corridors, waterways, seaways or other transport routes between cities and urban areas. Any or all of the vehicles may be anywhere on the scale from fully autonomous to fully driver/pilot controlled. Interactive Transport Networks are defined as involving roadside/ trackside/waterside/airside/new-route apparatuses that track the positions of vehicles in real time and provide tracking information to the vehicles to a high degree of accuracy, low latency, and high integrity. Such Interactive Transport Networks may include any systems which are suitable for this purpose, such as use of cameras to determine the position of vehicles within a field of view of the cameras to the required degree of accuracy. In an example of a possible Interactive Transport Network system, the system described in GB 2585165 A utilises vehicle tracking apparatuses which include an infra-red (IR) sensor to detect IR signals which are either emitted from or reflected by the vehicles in order to track the position of vehicles. The contents of GB 2585165 A and the tracking apparatus technology described therein are incorporated by reference in the present document. The present embodiments do not however rely on the specific tracking technologies described in GB 2585165 A, just on the provision of high-quality tracking data to vehicles from tracking apparatuses (devices) positioned along road carriageways, railway tracks, waterways, or new routes, typically with spacings similar to those of street/highway lighting or railway overhead power gantries. As such, these tracking technology apparatuses are external to the vehicles themselves, namely they do not require any part of the tracking apparatus to be placed within the vehicle itself. The present embodiments describe how such apparatuses can be made to work co-operatively to provide a range of traffic management and support capabilities for ground based, water-borne and/or airborne traffic.

It is to be appreciated that whilst tracking apparatuses are described herein which are provided to track the position and/or other kinematic parameters of vehicles to be monitored, in some envisaged embodiments, these positions and/or other kinematic parameters may be provided by appropriately configured vehicles themselves. For examples, vehicles may be provided with systems which are able to determine the required positions and/or other kinematic parameters to a high enough degree of accuracy in order to enable the functionality of the presently described management systems. In such embodiments, the tracking apparatuses referred to herein may simply be configured to receive information from the relevant vehicles indicating the position and/or other kinematic data of the respective vehicles. The tracking apparatuses in these instances may be further configured to transmit or otherwise provide the relevant information to the relevant features in accordance with embodiments described below (e.g. to a Local Area Network control apparatus).

The present embodiments provide systems and methods which together enable road/water/air vehicle traffic to be managed safely and at higher speeds and/or densities than previously possible in a wide variety of standard locations where vehicles must make route or manoeuvre selections such as at road junctions, exit lanes, splitting highways, harbours, airports etc. or where traffic streams merge such as on slipways, entry lanes, collector lanes, merging highways, flight path entries, etc. The traffic speeds and densities made possible by the present embodiments are significantly in excess of current limits and also enable airborne vehicle traffic to travel safely and efficiently above or near to such standard locations within cities or above motorways, freeways, roads, railways, or other routes between cities. The embodiments also provide related systems and methods that enable road traffic to be managed safely and efficiently in the event of abnormal operating situations such as planned road maintenance, exceptional vehicles, unplanned vehicle breakdown, vehicle collisions, emergency response, etc. The embodiments also provide related systems and methods that enable electric or hybrid electric powered vehicles, both ground-based and airborne, to be connected to sources of electric power either to provide motive power directly or to re-charge batteries ‘on-the-go’ through conductive or inductive electric power transfer in a more efficient manner than any pre-existing systems or methods. The embodiments also enable flexible road taxing and tolling systems that can adapt to traffic conditions, weather conditions, time of day/week/year, etc. Finally, some of the embodiments described herein also provide related systems and methods that enable vehicles fitted with appropriate monitoring equipment, for example deflection monitors on wheel suspension systems, as well as having the ability to transmit telemetry data gathered by such equipment, to provide such data back to the vehicle tracking equipment where it can be combined with the precise vehicle/wheel location and sent on to wide area monitoring systems to monitor the condition of road surfaces in real time and with levels of precision not previously achievable. This data can also create ‘events’ which ensure that subsequent vehicles can manoeuvre slightly to avoid defects in road surfaces and hence slow their growth. The systems and their methods of operation create localized Traffic Management Systems (TMSs) and Infrastructure Monitoring Systems (IMSs), either permanent or temporary, which are suitable in accuracy, performance, timeliness and integrity to enable all types of vehicle to operate on routes fitted with the systems and to be efficiently electrically powered or recharged on routes fitted with the systems of the embodiments described herein together with more conventional power transfer systems in a manner that increases the capacity of ground-based and water-borne transport networks or creates new airborne traffic routes above or to the side of them, in a safe and efficient manner.

It is a feature of the present embodiments that the multilateral, independent decision-making of driven and driverless vehicles according to the prior art is replaced with or supplemented by localised, organic TMSs, which in turn may be connected to and informed or controlled by regional or national TMSs. The engineering rationale is to locate monitoring and control functions at the level in the overall system architecture where they can operate optimally, in terms of performance, safety and cost-effectiveness. In this respect, consideration of the time constants associated with the various levels of monitoring and control provides the rationale. Features that must be located wholly and independently within the vehicle have the shortest time constants (typically milli-seconds), for example emergency braking, traction control, anti-skid, etc. Features that should be located in the localized TMSs described in these embodiments have intermediate time constants (typically tens of milli-seconds), for example normal steering, braking and acceleration in multi-vehicle co-operative control. Features that should be located in regional and national TMSs or established TASs such as Smart Motorways have the longest time constants (from seconds to days or even seasons) such as traffic density & flow control depending on demand, time-of-day, weather, natural light levels, etc.

It is a further feature of the present embodiments that conductive or inductive electrical power transfer systems either on overhead gantries or embedded in the ground or attached to the ground or attached to road-side structures requiring vehicles to enter specific powered lanes are facilitated to do so efficiently and safely and, furthermore, in the cases where the electrical power transfer is most efficient when the vehicle remains precisely positioned with respect to the infrastructure the present embodiments enable that alignment whether the vehicles are autonomous or driven. An example of this lies in the case of dynamic inductive power transfer between electrical coils in the road and electrical coils in a vehicle. Another example lies in the case of conductive power transfer between components (e.g. brushes) in the vehicle and components (e.g. rails) mounted in or on or near the road (similar to “third rail” electric railway systems). The present embodiments enable vehicles to maintain precise alignment (to within 1 cm) with the relevant road (or air) based infrastructure. Where coils embedded in the road need to be powered in synchronization with the vehicle passing above, the present embodiments also provide the precise timing required for such synchronisation. The present embodiments also enable electrical power transfer between a ground or waterborne vehicle and an air vehicle by enabling the two to travel in close proximity and alignment during a power transfer period. Thus, the present embodiments provide multiple benefits related to transport electrification:
a. maximizing the efficiency and hence reducing the cost of providing electrical power transfer to ground and air vehicles;
b. minimizing the time each ground vehicle needs to be in a dedicated power providing area of a road hence reducing the extent and amount of road-based infrastructure necessary to support a given traffic volume;
c. enabling vehicles requiring power transfer to be prioritized, scheduled, and managed into the dedicated power providing area of a road, hence further reducing the extent and amount of road-based infrastructure necessary to support a given traffic volume.

Hence, the systems and methods described in these embodiments rely upon measurement of the position (and other derived kinematic attributes) of vehicles to a localization accuracy (longitudinal, transverse) of around 1 to 10 cm with a dynamic latency of around 10 to 20 ms, weather tolerant, day or night, with an undetected hazardous fault rate in combination with safety-relevant vehicle based equipment of better than 1 × 10⁻⁸ failures per vehicle mile. Some aspects of these requirements may be different for different types of road, waterway or airway and different types of ground based, waterborne or airborne vehicle; however, there are clear criteria exemplified by the systems and methods of GB 2585165 A but are not assumed here to depend on the specific technologies described in GB 2585165 A and any suitable system may be used which enables the required measurement accuracy to be met.

It is also a feature of the present embodiments to provide within Interactive Transport Networks improved methods and systems for traffic management at specific locations, each location characterised by a contiguous series or one or more associated series of tracking/communication apparatuses that are organised, either permanently or temporarily, into a Local Area Network (LAN) to provide specific traffic management capabilities at the specific location. Each tracking/communication apparatus comprises the computing, communications, and other equipment necessary for tracking/monitoring a plurality of vehicles and transmitting track data between the tracking/monitoring apparatuses within the LAN (either directly or indirectly) and between LAN tracking apparatuses and vehicles. The tracking apparatus may or may not connect to or communicate with equipment fitted to one or more vehicles or may utilise tracking of specific features of the vehicles being tracked in order to track the vehicles. In further embodiments, the tracking apparatuses may additionally or alternatively utilise standard camera, radar, or other equipment to determine the position of vehicles. In some embodiments, the tracking apparatuses may include IR sensors which detect IR emissions which are either emitted by or reflected from the vehicles. One or more of the tracking apparatuses include equipment (such as transmitters, receivers, or transceivers) which enable data communication with the vehicles which are being tracked. Accordingly, the vehicles may also be provided with equipment suitable to receive and utilise the tracking data, or information related thereto, transmitted by the tracking apparatuses. In addition, these embodiments may require the vehicles or users of the vehicles to be provided with equipment suitable to transmit data from time to time to the tracking apparatuses in order to provide journey related information, for example their selected exit option when approaching a road junction, or their health status, for example their need to stop at a safe location due to a vehicle failure, or their battery charge status and prognosis for power transfer requirements or other information required by or useful to the traffic LANs and/or higher order TMSs and IMSs. The equipment provided to vehicles may comprise for example:
a. simply a mobile phone with an appropriate app installed; or
b. a dedicated ‘black box’ suitably positioned comprising the necessary computing, communications, and information display equipment; or
c. electronic equipment fitted for the purpose by the original car manufacturer; or
d. electronic equipment retrofitted for the purpose.

It is to be appreciated that in implementations of the present embodiments in which only some elements of the above-described functionality are to be included, the system may only include those features which are required to enable this functionality. For example, if it is not required for vehicles to transmit data to the vehicle tracking apparatuses, then the tracking apparatuses may not include receivers configured to receive such information.

By way of example, the method of operation of a tracking apparatus LAN is characterised by the following steps using the example of an exit junction on a carriageway of a motorway/highway where the LAN extends from a distance preceding the start of the slip lane (highway ramp such as an exit ramp) to the end of, or beyond, the slip lane:
a. each of the contiguous series of tracking apparatuses in the LAN continuously monitors the position of the plurality of vehicles within its tracking range, providing high-accuracy kinematic data to the vehicles about themselves and their neighbours, where the high-accuracy kinematic data is provided by any suitable system such as those described above. In embodiments in which the vehicles are configured to self-monitor and provide position and/or other kinematic parameters to the tracking apparatuses, this monitoring may comprise receiving the relevant information from the vehicles;
b. in the case of a vehicle intending to leave the motorway/freeway at the junction, the vehicle transmits a request signal to one or more of the tracking apparatuses;
c. each of the tracking apparatuses within the LAN continuously transmits the kinematic data about the vehicles (either determined by the tracking apparatus or received from the vehicles) in its range plus any requests from vehicles to leave at the junction to a single apparatus, the LAN control apparatus, which may be a designated member of the set of tracking apparatuses within the LAN or a separate apparatus. The LAN control apparatus maintains a continuously updated picture of the kinematic data of all the vehicles within the range of the LAN;
d. the LAN control apparatus processes the exit requests, calculates safe and efficient forward trajectories for all the vehicles within range of the LAN and transmits advisory, compulsory, or direct control signals back to the vehicles to ensure the necessary manoeuvres can be executed safely.

The method of operation of tracking apparatuses for water-borne traffic is very similar and conveniently located around areas where there is high traffic demand such as harbours. Navigation at sea and in open waters is typically and perfectly adequately managed using conventional systems such as Radar, GPS (Global Positioning System) and AIS (Automatic Identification System). However, in complex, high traffic zones such as harbours which may involve hundreds of berths, locks and approach/exit lanes handling thousands of boat manoeuvres a day the current embodiments will increase both the efficiency and safety of marine operations.

The method of operation of upwards-facing tracking apparatuses (i.e. apparatuses configured to monitor airborne vehicles) is also very similar, however the air vehicles maintain a constant altitude by virtue of independent and quite separate mechanisms, examples of which are described in GB 2585165 A. Maintenance of constant altitude creates a ‘road in the sky’ element of an Interactive Transport Network and enables upwards-facing tracking apparatuses along roads, rail tracks or new routes to operate in many ways analogously to the downward facing tracking apparatuses. The road in the sky may have multiple lanes, configured, for example, at different altitudes and monitored by upwards facing tracking apparatuses arranged along sub-sets of the lampposts on which the downwards facing ones are fitted. For example, one lane may be at an altitude of 150 ft and monitored by tracking apparatuses located on ‘odd’ lampposts and a second lane may be at 300 ft and monitored by tracking apparatuses located on ‘even’ lamp-posts, all configured in such a way that the fields of view of the two sets of upwards facing tracking apparatuses do not interfere with each other. Whilst high volumes of low-level airborne traffic such as delivery drones and air-taxis are not yet established there are many predictions that they will be. In the early phases of growth of this type of traffic it is likely that the present embodiments will provide for safe and efficient traffic management around locations analogous to harbours - for example in a ‘drone goods yard’ that is the focus for package pick-up, take-off and return flight landing. The safety case for an Interactive Transport Network is summarised in GB 2585165 A and is completely compatible with the systems and methods for traffic management contained in this invention

In a convenient arrangement, the LAN control apparatus may also be connected to regional or national Traffic Management Systems (TMSs) to provide a shared, common picture comprising the high accuracy kinematic data about or derived from vehicles across a wider field spanning multiple LANs. This provides the TMSs with live, accurate data for each LAN and even for each vehicle and allows the TMSs to augment the kinematic data provided to vehicles about their immediate locality with advisory or compulsory or control information that the on-board systems or drivers/pilots deal with relating to their journeys and the traffic across the wider transport network.

There now follows, by way of multiple examples of the systems and methods provided by the present embodiments, detailed descriptions that are to be read with reference to the accompanying drawings referred to above. It is to be appreciated that the examples provided are for the purposes of illustration and are not intended to be limiting. Described features may be substituted for other features which enable the described functionality.

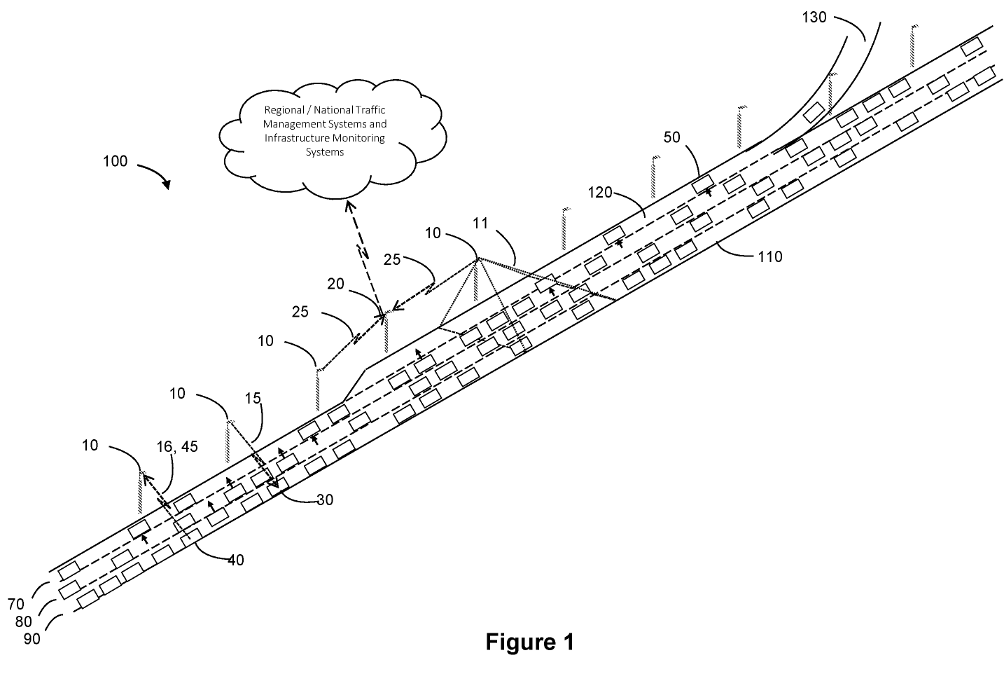

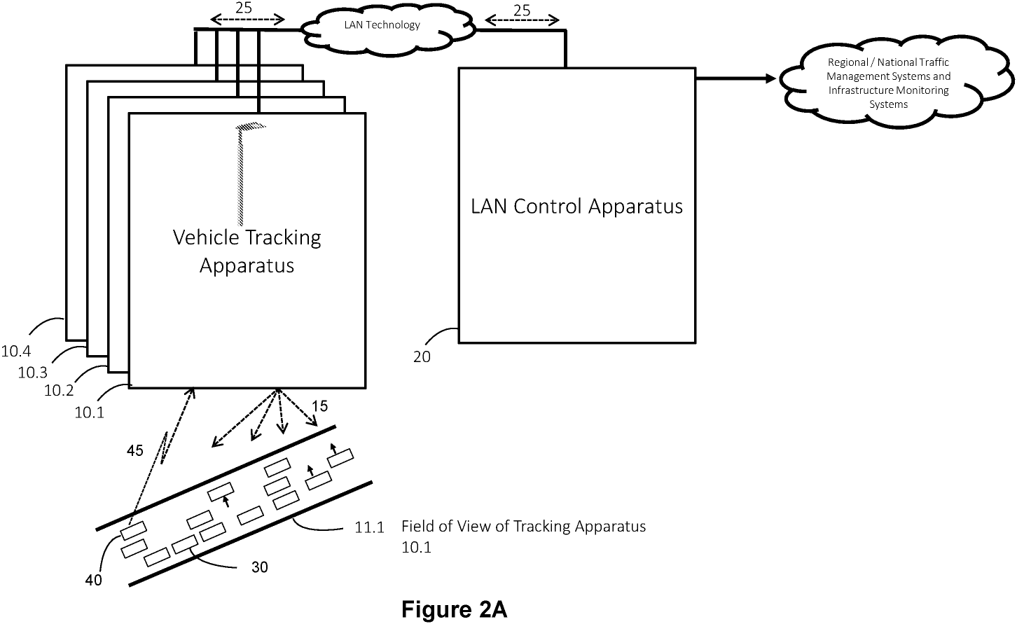

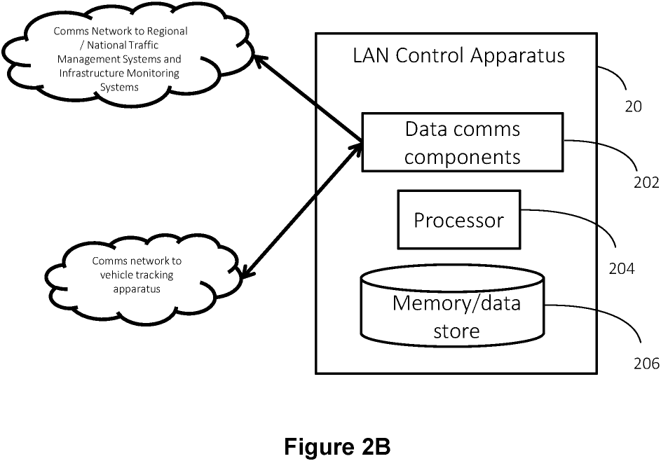

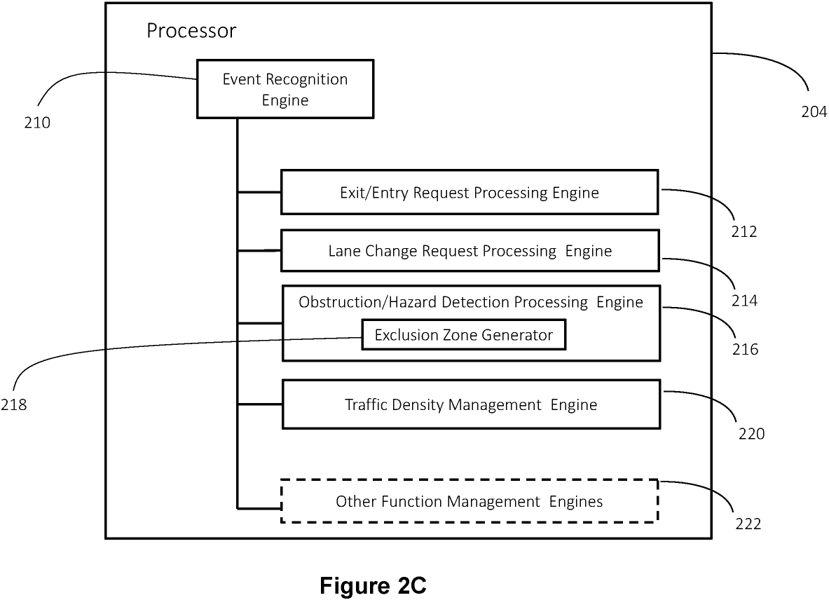

The system illustrated in FIGS. 1 and 2A comprises a typical motorway/freeway 110 with three traffic lanes 70, 80, 90 and with an exit junction comprising a slipway 120 and an exit lane 130 with all of the traffic being tracked by vehicle tracking apparatuses 10 mounted on a contiguous series of lamp-posts or other infrastructure, the apparatuses having fields of view 11 which ensure that all vehicles are tracked continuously and accurately at all locations throughout FIG. 1. The vehicle tracking apparatuses 10 shown in FIGS. 1 and 2A, are organised into a Local Area Network (LAN) to provide specific traffic management capabilities at the specific location in accordance with embodiments described above. Each vehicle is also fitted with communication equipment connected to its on-board systems or displaying data to its driver that enables it to receive kinematic data 15 from the tracking apparatuses 10 and optionally to transmit journey, health-related and other data 16 to the tracking apparatuses. The other data may comprise information which indicates an event which has taken place which requires a control action to be calculated and transmitted back to one or more of the vehicles, where the control action results in one or more kinematic parameters of the vehicles to be altered. Examples of events are described below with reference to FIGS. 1, 2A, 2B and 2C.

Each tracking apparatus 10 contains equipment that allows it to communicate 25 with its upstream and downstream neighbours within and possibly beyond the LAN and, either directly or possibly via the intervening apparatuses, with a LAN control apparatus 20. The LAN control apparatus 20 will be described in greater detail with reference to FIG. 2B.

It is to be appreciated that for the purposes of ease of illustration, only two communications channels 25 between tracking apparatuses 10 are shown in FIG. 1, but that communication may be enabled between any two tracking apparatuses 10. The LAN of vehicle tracking apparatuses extends from a fixed distance before the exit to at least the end of the slip lane 120 and may extend into and beyond the exit lane 130 and beyond the junction on the main carriageway 110, as required for efficient and safe traffic manoeuvres.

FIGS. 1 and 2A show at 30 one of a plurality of vehicles that do not intend to exit at the junction (but may have to manoeuvre to enable other vehicles to exit) and at 40 one of a plurality of vehicles that transmits a signal 16 to one or more of the vehicle tracking apparatuses 10 indicating its intention to exit. This is an example of an event. It should be appreciated that the term ‘manoeuvre’ as used herein covers all changes in kinetic behaviour of a vehicle which includes a change of direction, altitude, and/or speed. All exit requests (event data) are transmitted from the tracking apparatuses to the LAN control apparatus 20 along with the tracking data (sensed kinematic parameters) that is continuously being generated for all vehicles within the LAN field of view. As shown in FIG. 2B, the LAN control apparatus 20 comprises at least a memory/data store 206, a processor 204, and data communications components 202 (such as data transmission and data receiving components). The processor 204 is described in greater detail below, with reference to FIG. 2C. The data communication components 202 enable the LAN Control Apparatus 20 to communicate downstream, via the comms network, with the vehicle tracking apparatuses 10 Similarly, the data communication components 202 also enable the LAN control apparatus 20 to communicate upstream, via the comms network, with the Regional/National Traffic Management Systems and/or with Infrastructure Monitoring Systems. For all the vehicles 40 within the field of view of the tracking apparatuses 10 communicating with the LAN control apparatus 20, the LAN control apparatus 20 stores all of the ‘intention to exit’ signals received from any vehicles 40 and enough of the recent kinematic data regarding the vehicles 40 within the field of view of the vehicle tracking apparatuses 10 to allow its processor 204 to calculate the future movements and manoeuvres of vehicles that will ensure that the plurality of vehicles 40 on the main carriageway move safely to become vehicles 50 on the exit slip lane 120 and then onto the exit lane 130. The LAN control apparatus transmits, either directly or via the vehicle tracking apparatuses 10, information defining the required manoeuvres (namely positional control instructions) to the vehicles 40 that are exiting and any of the vehicles 30 that need to manoeuvre to allow passage of the vehicles 40 to exit.

Turning to FIG. 2C, there is shown a schematic representation of the processor 204 of the LAN control apparatus 20 shown in FIG. 2B. The processor 204 comprises an event recognition engine 210 which is configured to identify an event type which is contained within data which has been received by the data communication components 202 of the LAN control apparatus 20. The event type may be any occurrence within or beyond the LAN which requires that the kinematic parameters of one or more of the monitored vehicles to be altered in order to ensure efficient and safe continuous traffic flow in accordance with the requirements of each vehicle. In the example of FIGS. 1 and 2A, this data comprises the signal 16 that is transmitted by a vehicle indicating its intention to exit at a junction. However, it is to be appreciated that the range of events which may be received by the LAN control apparatus 20 are not limited to this type of event, nor does the event necessarily require that a dedicated signal 16 be sent in order to be identified as such an event. For example, the LAN control apparatus 20 may receive tracking data from a vehicle tracking apparatus 10 which indicates that a particular monitored vehicle is no longer travelling at its expected speed (such as in the case where the vehicle has suffered a malfunction). In such a case, no signal will have been received from the vehicle indicating that an event has taken place, but rather such an event may be determined elsewhere and communicated to the LAN control apparatus. However the system still needs to determine actions which enable other vehicles in the area to efficiently and safely navigate around the malfunctioning vehicle, in order to maintain a stable traffic flow. Events may also not relate to any occurrence within the traffic network but may relate to an instruction to alter the traffic network conditions, such as changing the average speed at which each monitored vehicle is moving, or to reduce or increase the distance between the vehicles in order to alter the average traffic density or flow rate. Such instructions may be received from locations external to the monitored traffic network, such as from the regional or national TMS’ and infrastructure monitoring systems.

Returning to FIG. 2C, the event recognition engine 210 is configured to identify a particular type of event from data which has been received in accordance with embodiments described above. Following the identification of the event, the data is then passed to an appropriate processing engine for the particular event. Once the data is received by the appropriate engine, that engine will then process the data in order to calculate one or more control actions for each of the monitored vehicles in response to the received event. In some cases, this will comprise determining actions for each of the monitored vehicles. In other cases, only a subset of all of the monitored vehicles are required to take an action. In further cases, it may be determined that no vehicles are required to take any action. Following calculation of the control actions, the actions (in the form of instruction signals) are then transmitted, either directly or via the vehicle tracking apparatuses. These instruction signals include information defining the required manoeuvres (namely positional control instructions) to the vehicles 40, in accordance with the embodiments described above.

By way of example, FIG. 2C provides illustrations of a plurality of processing engines relating to particular event types. There is firstly shown an exit / entry request processing engine 212. This engine 212 would be provided with received data when it is identified by the event recognition engine 210 that a request is received from a vehicle either to exit or enter a particular geographical location of a traffic network (e.g. by using an entry of exit slip road on a motorway or freeway).

There is also shown a lane change processing engine 214. This engine 214 would be provided with received data when it is identified by the event recognition engine 210 that a particular vehicle should change lanes. This may occur where a vehicle has requesting to enter a particular lane which has electrical charging capabilities (which is described in further detail below).

Further, there is shown an obstruction / hazard detection processing engine 216. This engine 216 would be provided with received data when it is identified by the event recognition engine 210 that a vehicle has broken down or otherwise is malfunctioning or, more generally, where it is identified that there is an obstruction in the geographical location which prevents vehicles from accessing a particular section of the transport network (e.g. where an object has been dislocated from a heavy goods vehicle or a tree has fallen onto the road). In this instance, no direct signal need be received from a vehicle to highlight the event, but the event recognition engine 210 may identify that a vehicle is not performing in accordance with determined parameters, or that a portion of the road is blocked. The obstruction/hazard detection processing engine determines the precise geographic location of such a hazard. The obstruction / hazard processing engine 216 is provided with an exclusion zone generator 218 for determining a strategy to avoid the hazard, namely by setting up an exclusion zone around it. In some instances where it is determined that an obstruction will be present for an extended period of time, the obstruction / hazard processing engine 216 (using the exclusion zone generator 218) may be configured to identify areas of the traffic network at the geographical location which may not be entered by a vehicle until the obstruction is cleared. This exclusion zone may be stored in the memory / data store 206 of the LAN control apparatus 20 to be readily accessible. This can be used in order to prevent the need for recalculation of an exclusion zone each time a control action is to be taken in response to an event. Once an exclusion zone is generated, this may be automatically configured to be included in each subsequent control action to be calculation and executed. The exclusion zone can be removed once the hazard/obstruction is cleared.

FIG. 2C also shows a traffic density management engine 220. This engine 220 would be provided with received data when it is identified by the event recognition engine 210 that a request for a change in traffic density or flow rate is to be enacted (either by altering the average speed of monitored vehicles and / or to alter an average distance between vehicles). This would typically be received from locations external to the monitored traffic network, such as from the regional or national TMS’ and infrastructure monitoring systems. Alternatively, such traffic density could be monitored by the traffic density management engine 220 and if the density or flow rate parameter falls below a predetermined level, this could instigate the Traffic Density Management Engine 220, to generate one or more instruction signals to manoeuvre one or more vehicles to increase the density to the required predetermined levels.

It is to be appreciated that the engines and events described above are a non-exhaustive list of possible events which may be processed by the LAN control apparatus 20 and other events may be responded to (by calculation of appropriate control actions) which are not described here. Also, in other embodiments only one or some of the listed engines may be provided. It is intended that the processor 204 may be configured to process these events by the appropriate addition of subsequent engines arranged to carry out software instructions to calculate appropriate control actions in response to these events. FIG. 2C highlights this by the inclusion of potential “other” function management engines 222.

It is also to be appreciated that where description is provided regarding the tracking apparatuses 10 “sensing” or otherwise determining kinematic parameters of vehicles, in some additional embodiments, the vehicles may be configured to determine these parameters themselves, and the tracking apparatuses 10 may be configured to receive a transmission providing this information from the relevant vehicles. In such embodiments, the tracking apparatuses 10 may be configured to receive this information from the relevant vehicles and to transmit the information, along with the event data to the LAN control apparatus 20. It is also envisaged that there may also arise a scenario in which some of the vehicles are able to determine their own relevant kinematic parameters for use in the present system, and some of the vehicles are unable to do so. In such scenarios, the tracking apparatuses 10 may be configured to determine the kinematic parameters of vehicles which do not provide this information, and to receive the information from vehicles which can. In yet further embodiments, the tracking apparatuses 10 may be configured to perform a verification of kinematic parameters received from vehicles wherein the tracking apparatuses 10 determine the kinematic parameters in accordance with embodiments described above and compare these with the kinematic parameters received from the vehicles. Where the parameters agree, these are sent to the LAN control apparatus 20. Where they disagree, an error message may be transmitted to both the relevant vehicle and the LAN control apparatus 20 to notify each of the potential misconfiguration. In such scenarios, the determined parameters either determined by the tracking apparatus 10 or received from the vehicle may be preferentially used to determine manoeuvre actions (as described above), in accordance with user determined settings.

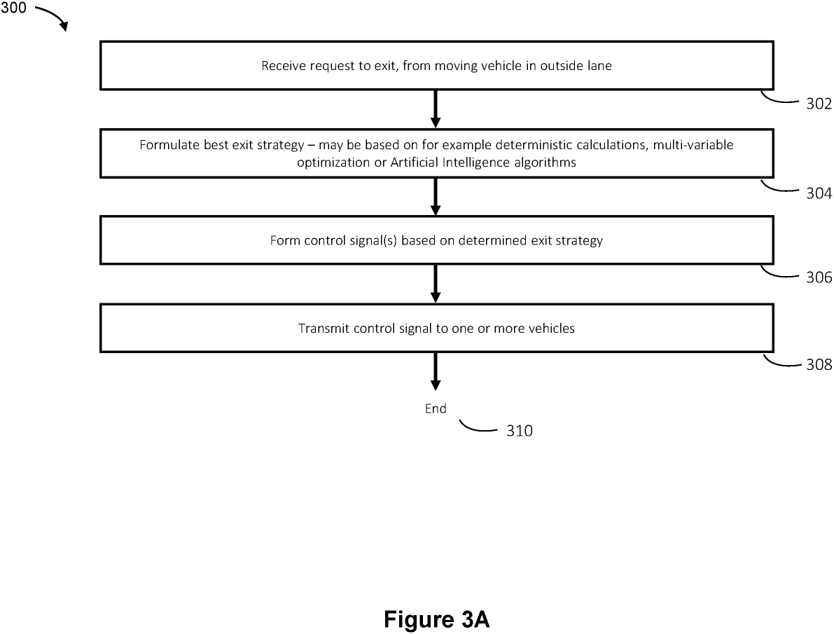

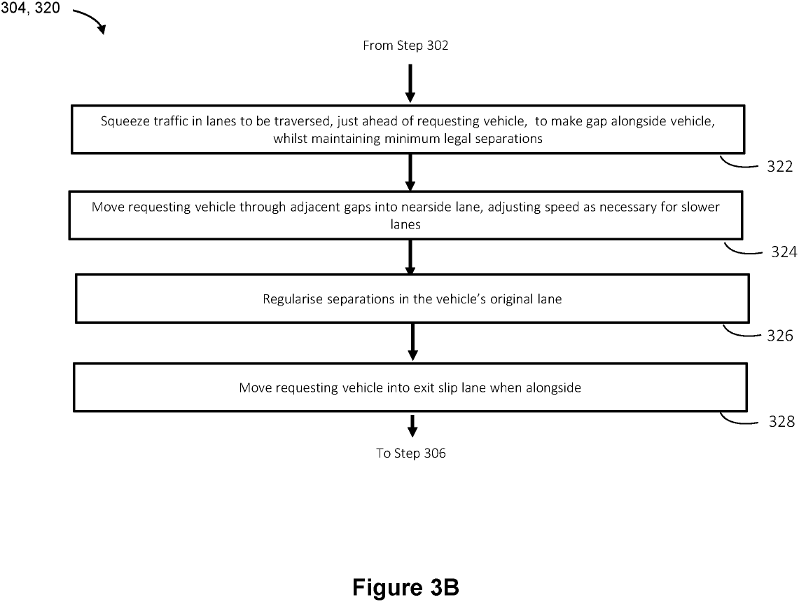

FIG. 3A shows a functional flow chart 300 for an example of the calculations that would be carried out utilising the LAN control apparatus 20 in FIG. 1 in order to provide to the vehicles within the field of view of the LAN apparatuses with the information defining the required manoeuvres. In particular, FIG. 3 shows an example of the operation of the Exit/Entry Request Processing Engine of FIG. 2C. As a fairly demanding example, lanes 80 and 90 may have traffic flows comprising cars each 4 m in length and 20 m separation travelling at 36 ms⁻¹ (130Kph) and lane 70 comprises trucks each 12 m in length and 20 m separation travelling at 28 ms-1 (100Kph). Compared with current free flowing traffic this represents some 350% increase in traffic densities and hence flow rates well above current, conventional freeways / motorways / highways and would be a typical normal operating design case for autonomous/semi-autonomous vehicle traffic on a freeway/motorway/highway. It is assumed that there are regular requests 45 from vehicles 40 entering the field of view of the LAN to leave at the junction and it is further assumed that safety and operating regulations require that vehicle separations must not be less than 16 m in any circumstances.

At Step 302 in FIG. 3A the LAN control apparatus receives, possibly via other tracking apparatuses, an exit request from vehicle 40 in lane 90 (FIG. 1). Assuming there are no additional convenient requests from nearby vehicles in lanes 70 and 80 that will create space, the LAN control apparatus 20 (using the Exit/Entry Request Processing Engine 212) determines at Step 304 at least a viable and preferably an optimal exit strategy comprising a set of manoeuvres for a plurality of vehicles within the field of view of the LAN. Such manoeuvres may include changes in positioning and velocity of the vehicles. A range of possible techniques may be used by the processor 204, an associated software program, and memory 206 of the LAN control apparatus 20, from simple deterministic calculations to artificial intelligence algorithms. Once this strategy has been established, the method proceeds to form, at Step 306, one or more control signals (also referred to as instruction signals) based on the determined exit strategy. The one or more control signals will typically be of a form which may be enacted by the vehicles they relate to. It is to be appreciated that typically in order to formulate an exit strategy, it is necessary for a plurality of vehicles to perform a set of manoeuvres (e.g. to create a space for the requesting vehicle to enter into). As such, at Step 306, typically multiple control signals are generated, each intended for a particular recipient vehicle and comprise the particular set of manoeuvres that this particular vehicle needs to enact. Following the generation of the one or more control signals, the method then proceeds to transmit, at Step 308, the generated control signals to the associated vehicles. The transmission may occur directly from the LAN control apparatus 20 to the vehicles, or may occur via one or more of the vehicle tracking apparatuses 10. The vehicles are then manoeuvred to effect the exit of the vehicle. It is to be appreciated that the strategy may have conditional aspects to it. For example, once instruction signals are sent to vehicles to create a space in a particular lane for an exiting vehicle, the timing on when the instruction for the exiting vehicle to also manoeuvre is sent, can be made dependent on the LAN sensing that the space has indeed been created. This provides an additional safety feature for the system and also enables the system to be used with semi-autonomous vehicles. The method then proceeds to end at Step 310.

A detailed example 320 of an exit manoeuvre is now described with reference to FIG. 3B. It is envisaged that such an example may be utilised as part of the formulation in Step 304, following the request received at Step 302. At Step 322 the manoeuvres may make space in lanes 70 and 80 alongside vehicle 40 through which vehicle 40 can pass and then exit onto the slip lane 120. This could be achieved by the six vehicles in lane 80 just ahead of vehicle 40 being instructed in parallel to speed up temporarily, closing each of the 6 gaps in front of them to 16 m, creating a gap of 36 m centered alongside vehicle 40. The same traffic squeezing strategy could be carried out in parallel in lane 70, although initiated somewhat further downstream due to the slower speed of lane 70 traffic. It is to be appreciated that such a manoeuvre is given by way of illustration only, and that other manoeuvres are available which enable the desired functionality of allowing vehicle 40 to exit onto the slip lane 120.

At Step 324 the exiting vehicle is moved into the gap alongside it in lane 80, which in this example does not require a change in speed for the exiting vehicle, and then immediately into the gap in lane 70, the gap having ‘arrived’ at the right moment, with a reduction in longitudinal speed during the lateral movement. This whole manoeuvre can easily be calculated to take around 10s at the speeds assumed, during which time the requesting vehicle will have travelled around 360 m - perhaps 20% of the distance from the start of the LAN apparatuses to the exit junction. There would thus be the capacity, using this crude exit strategy and with the very high traffic flow rates involved, to allow 25% of the traffic flow to exit at the junction.

At Step 326 the gap left in lane 90 by the exited vehicle can be evened out, filled by advancing the following traffic or perhaps maintained as a gap in preparation for the likely influx of vehicles that normally occurs at the entry junction immediately following an exit junction. Finally, at Step 328, when the exiting vehicle is alongside the exit slip lane, and assuming the exit slip lane is monitored by the tracking apparatuses as having sufficient capacity, the exiting vehicle can be instructed to be moved into the slip lane. Additional gaps left in lanes 70 and 80 may be treated analogously to the gaps in lane 90 described above once the vehicle 40 enters the slip lane. The example 320 would then proceed onto Step 306 of FIG. 3A by generating a control signal in accordance with the determined exit strategy.

There are many different predictable scenarios that the LAN control apparatus 20 is programmed to deal with safely, including as a typical example the situation where the exit lane 130 in FIG. 1 is congested and the slip lane 120 becomes progressively congested. This may lead to the slow lane 70 of the main carriageway becoming congested or stationary and the LAN control apparatus 20 may then extend the range of tracking apparatuses 10 that it is controlling upstream. As such it is intended that the size of the LAN may be variable in dependence upon the present requirements of the system. Another typical example would be a vehicle 50 on the slip lane 120 decides to return to the main carriageway, in which case a more time-critical manoeuvre may be formulated and communicated to the affected vehicles by the LAN control apparatus 20, or the request for this manoeuvre may be denied, namely not permitted by the system. In some embodiments, the various requests monitored by the LAN control apparatus 20 may be ranked hierarchically. This hierarchy may, for example, be determined by time and distance restrictions associated with a particular manoeuvre, with those with shorter times and distances being executed first. In some embodiments, a plurality of manoeuvre requests may be received simultaneously and each of these requests may be considered simultaneously by the LAN control apparatus 20 in order to determine an appropriate exit strategy for all requesting vehicles 40.

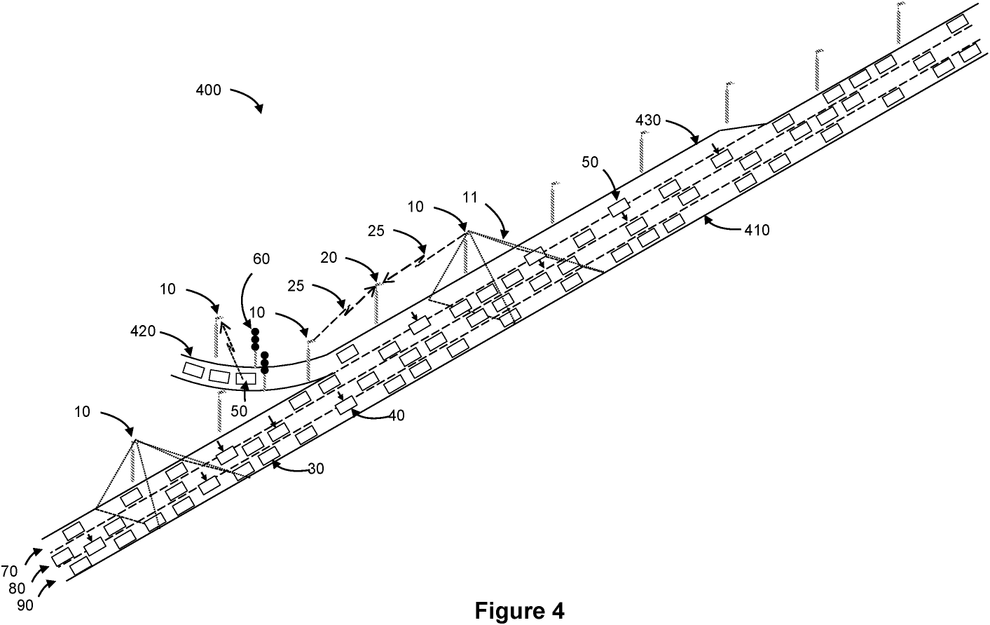

FIG. 4 shows, as another example of the present embodiments 400, the complementary situation of an entry lane 420 and slip lane 430 onto a carriageway 410. The method of operation of the LAN is completely analogous with vehicles 30 on the main carriageway that are not affected and vehicles 40 that have to manoeuvre to make way for vehicles 50 that are joining the main carriageway. In the scenario where the main carriageway does not have capacity to accept the flow rate of vehicles 50 wanting to join then the incoming traffic on the entry lane 420 is metered by ‘virtual traffic lights’ 60 in the form of control or advisory commands from the tracking apparatus on the entry lane. Such commands may be determined by the LAN control apparatus 20 as part of determining appropriate entry manoeuvres. Since highway / motorway / freeway junctions often comprise both exits and entries in close proximity, it may be convenient for the exit LAN control apparatus and the entry LAN control apparatus to communicate with each other in order to further improve the performance of the traffic management at the junction. It is also to be appreciated that ‘virtual traffic lights’ may also be included on an exit slipway where appropriate.

As an example, on a typical highway/motorway/freeway the separation between lampposts is ≈ 40 m and therefore for a 3-lane carriageway there could be up to an absolute maximum of around 20 vehicles within the field of view of each tracking apparatus, assuming they are all average size cars travelling with only 1 m nose-to-tail separation (an extreme limiting case which may be achieved only after progressively deploying and proving the system with gradually increasing traffic densities). An exit slip lane as in FIG. 1 typically extends along 500 m and in addition around a further 1500 m of main carriageway before the exit slip lane may need to be involved in preparatory vehicle manoeuvres. There may therefore be around 50 vehicle tracking apparatuses in the LAN and in the limiting case of maximum traffic density around 500 vehicles. This may be translated into a required communication capacity of around 100Kbps between vehicle tracking apparatuses, equating to a maximum 5Mbps in the worst case of apparatus 49 transmitting the tracking data for apparatuses 1-49 through to apparatus 50, well within the current capabilities of both wired and wireless technologies.

FIGS. 1 to 4, as described above, implicitly assume that all vehicles can be detected by the vehicle tracking apparatuses and that all vehicles can receive and utilise tracking data and advisory, compulsory or control commands to manoeuvre as required. Whilst this is the desired future state for traffic management within Interactive Transport Networks there will be a prolonged period during which there is a mix of vehicles with varying degrees of autonomy and during which there will be a mix of vehicles that can be detected and communicated with and vehicles that cannot. It is envisaged that the systems and methods of the current invention, and of GB 2585165 A can be progressively deployed. As an example, when detectable, and potentially controllable cars are in the minority the fast lane only could be dedicated to those vehicles and their joining and leaving that lane could be automated with driver intervention should a non-detectable car intervene. As a second example of an intermediate configuration, the stretches of a freeway/motorway/highway between junctions may be configured for fully autonomous operation in one or two of the three lanes under the control of some or all of the systems and methods of this embodiment, yet on the approach to junctions all vehicles may revert to driver control so that the necessary manoeuvres can be made in the traditional manner.

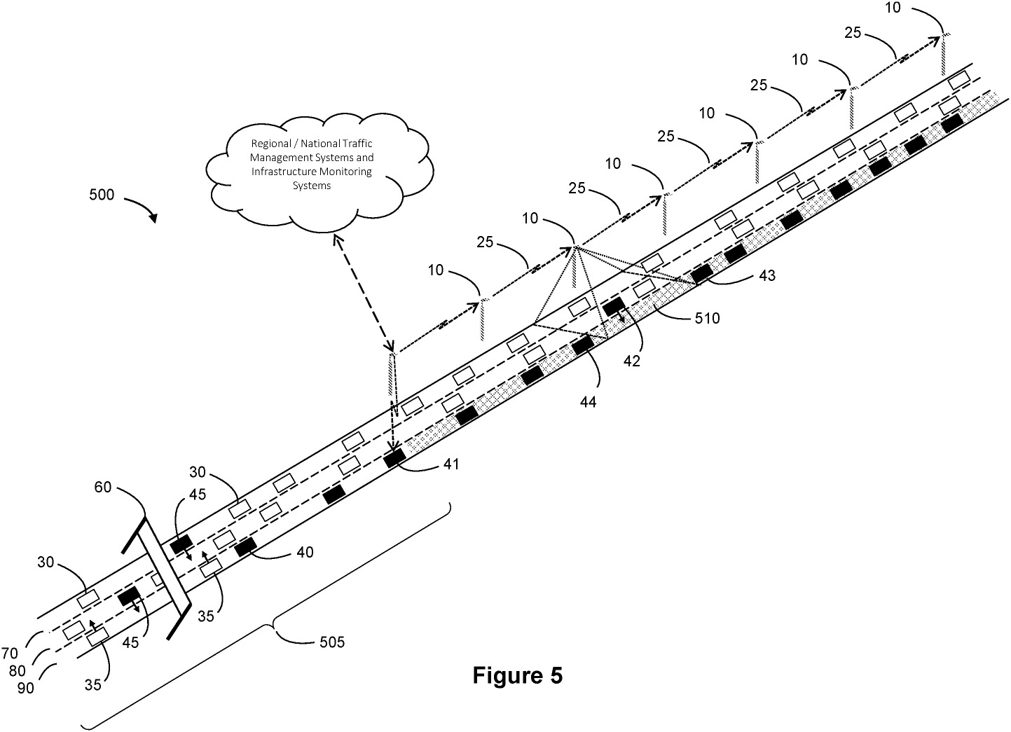

FIG. 5 shows, as an example 500 of such a situation where only some of the vehicles on a standard freeway/highway/motorway 505 are detectable by the tracking equipment to a level of tracking accuracy required by the system of the present embodiment. There is shown a transition from a stretch (portion) of standard freeway/highway/motorway 505 to a stretch (tracked section) where some of the vehicles can be tracked accurately and enabled by the sending of control signals to operate autonomously. Hence, on the approach to the tracked section, there is a randomly positioned mix of detectable (black) and undetectable (white) vehicles all under driver control (namely all operating in a non-autonomous manner). The tracked section comprises one lane 510 that will support autonomous vehicle operation enabled by the present embodiments, the other two lanes being used for standard, driver-controlled traffic that cannot be detected and tracked to the level of accuracy required. On the standard section 505 there is standard road signage 60 requiring vehicles to be manoeuvred by their drivers into the appropriate lanes, so white vehicles 35 must leave the fast lane and black vehicles 45 are required or can opt to join it. FIG. 5 shows some different scenarios. For example, on entry to the tracked section 510, vehicle 41 has just been detected by the tracking apparatus and possibly validated via the link to the regional traffic management system. This detection may also be used as an essential component of a vehicle tolling service. FIG. 5 also illustrates the scenario where vehicle 42 is in the wrong lane as it has either omitted to move into the fast lane or has just decided to enter it (later than it should have). The methods described above in association with FIGS. 1 to 4 are then applied to send instruction signals to vehicles 43, 44 in the tracked lane 510 and to vehicle 42 outside the tracked lane to safely manoeuvre vehicle 42 into the autonomous operation, tracked lane 510.

In some embodiments, the system may also be configured to be able to detect vehicles or other obstructions which may be present on the road, in the water, or in the air, even where these vehicles or obstructions cannot be communicated with in order to provide them with advisory or control information. This information may additionally be used when a LAN control apparatus is determining kinematic actions to be taken by vehicles that can be provided with advisory, compulsory or control information, in order to take the non-controllable vehicles or obstructions into account. For example, referring back to FIG. 1, there may be a scenario in which a vehicle 40 wishes to move to an exit slipway 130 but due to a non-communicable object being present in one of the lanes 70, 80, the vehicle 40 may be restricted in where movement is possible. This could be due to large detritus having fallen from a lorry, or simply the presence of a non-communicable vehicle. By including this additional functionality, the system can prevent unexpected collisions. The system may be configured such that the vehicle tracking apparatuses 10 (or any similar tracking equipment) are able to detect such obstructions and provide this obstruction data to the LAN control apparatus. Additionally, or alternatively, the tracking apparatuses 10 may be configured to receive telemetry data from the vehicles 10 that are communicably coupled to the vehicle tracking apparatuses 10 to receive such obstruction information. For example, a vehicle 30 may contain forward or rear facing radar which detects an obstruction in its vicinity and this telemetry may be provided to the LAN control apparatus 20 via a vehicle tracking apparatus 10. This may be used to detect an unexpected obstruction (i.e. an obstruction which is not known as another vehicle 30 on the road, in the water, or air), and appropriate action may be taken when calculating manoeuvres. Whilst an example of radar derived data is given, any relevant telemetry data may be used for this purpose (e.g. braking information used when slowing down as a result of the obstruction).

From the examples described above it is clear how the same methods and systems would be extended to the wide range of standard traffic control scenarios that exist, not just on freeways/ motorways/highways but on all city, urban and cross-country routes. The example of a high-speed, high-density road was selected as it involves a LAN with the largest number of vehicle tracking apparatuses and the highest traffic densities and flow rates, thus placing the maximum demand on the LAN control apparatus and on the communication between apparatuses. Equally, the systems and methods of the current embodiments also extend to the airborne traffic scenarios described in GB 2585165 A for example, albeit with radically different vehicle dynamics and traffic densities.

In examples provided above, the present embodiments have been described in the context of a LAN control apparatus 20 being arranged to calculate appropriate manoeuvres following a “trigger” event (e.g. exiting/entering an area of road, occurrence of an accident). However, it is also envisioned that in some embodiments, the system may be arranged for continuous monitoring of an area of road, water, or airspace by the LAN control apparatus 20, and that the LAN control apparatus 20 may be arranged to provide control or advisory information to vehicles 30 even in the absence of such an explicit trigger event. This may be useful in general traffic flow management to enable increased traffic densities / average traffic speeds where appropriate to do so. In such embodiments, the LAN control apparatus 20 may continuously receive kinematic / telemetric data regarding vehicles 30 via vehicle tracking apparatuses 10 and may calculate that an action can be taken to increase the efficiency of traffic flow (for example when the traffic density has fallen below a predetermined minimum). This may comprise closing spaces between vehicles 30 or increasing the velocities of one or more vehicles 30. The communications channels required for such management are analogous to those described in embodiments above and the determination that a traffic density is to be increased (perhaps because it is below a predetermined level) is considered to be the event about which event data is received

In some embodiments, the communication between vehicle tracking apparatuses 10 in the system and the LAN control apparatus 20 may occur in parallel. This to say that each vehicle tracking apparatus 10 can be configured to have a direct communication channel with the LAN control apparatus 20 along which data is exchanged. In other embodiments, the communication between vehicle tracking apparatuses 10 in the system and the LAN control apparatus 20 may occur in series. In such embodiments, the vehicle tracking apparatuses 10 may be configured to be communicably coupled to vehicle tracking apparatuses 10 adjacent to it, and may be configured to transmit data between one another, essentially “passing” the data along a chain. In this embodiment, one of the vehicle tracking apparatuses 10 may be configured to be communicably coupled with the LAN control apparatus 20 and transmit and receive data relevant to all vehicle tracking apparatuses 10 in the LAN.

In some examples, the systems implemented may enable a “standardised” method of communicating between TMSs / IMSs / Local TMSs with vehicles 30. Such a standard may be implemented and required unilaterally across all such systems and vehicles, ensuring compatibility between various manufacturers of equipment and vehicles 30. This may circumvent problems with present systems as highlighted above where due to varying standards implemented by different manufacturers, a safe and reliable system is not practicable.

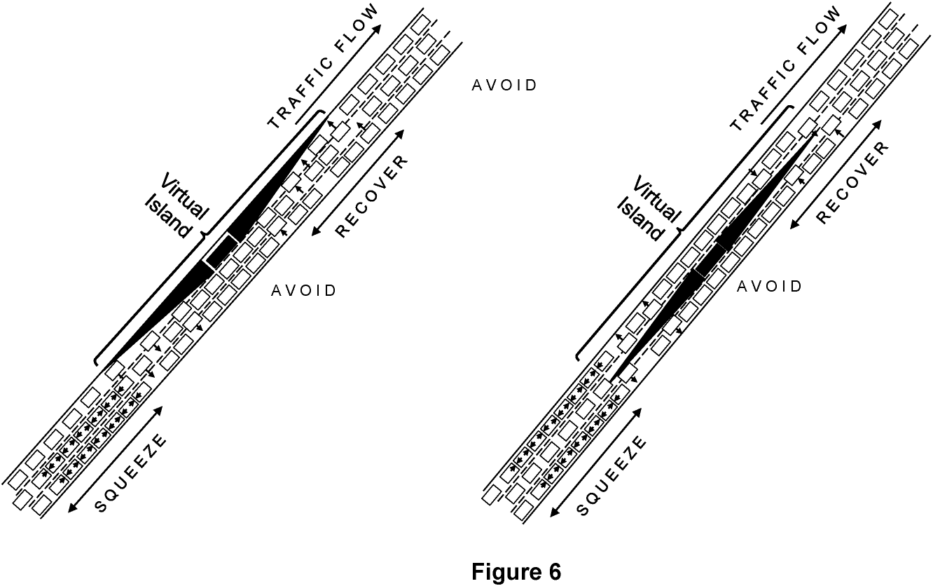

The current embodiments also provide closely related systems and methods that enable road traffic to be managed safely and efficiently in the event of abnormal operating situations such as planned road maintenance, exceptional vehicles, unplanned vehicle breakdown, accidents, emergency response, etc. FIG. 6 shows two scenarios of a carriageway on a fast freeway/motorway/highway on which one of the vehicles has broken down in each of 2 lanes. It is assumed that the vehicle tracking apparatuses 10 on this road are simply providing kinematic data to vehicles which are operating either autonomously, semi-autonomously or under driver control. In this situation, the faulty vehicle either communicates to the vehicle tracking apparatuses 10 its fault status and stopping prognosis or the tracking apparatuses simply track the slowing and halting of the vehicle. During the slowing period, adjacent and affected vehicles respond either autonomously, semi-autonomously or under driver control. The vehicle tracking apparatuses 10 however are programmed to nominate one apparatus, near to the stopping place of the faulty vehicle, to take on the role of LAN control apparatus 20 and to define a contiguous series of adjacent apparatuses to be in that temporary LAN.

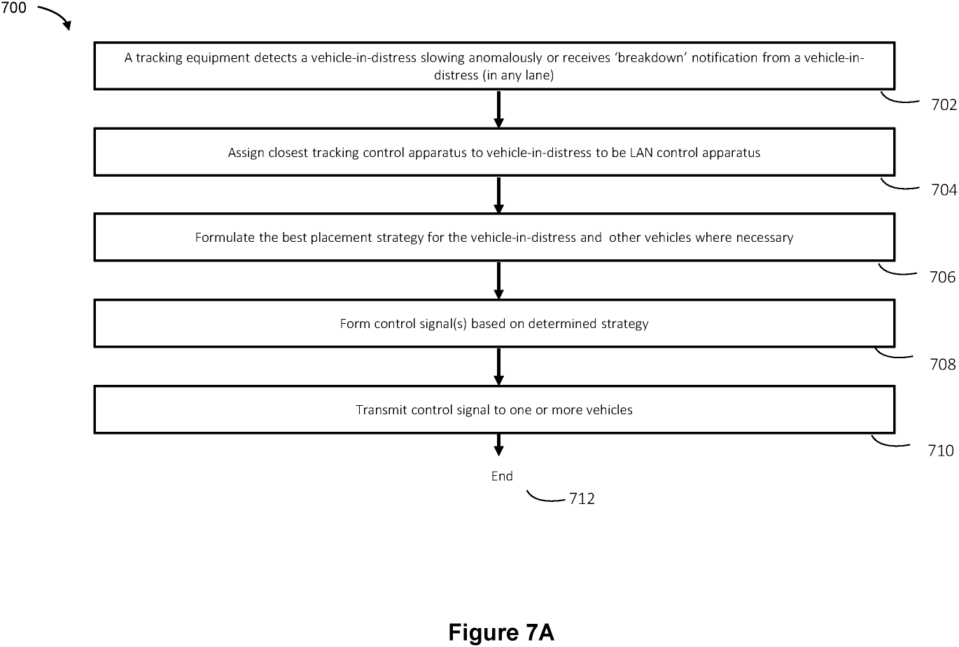

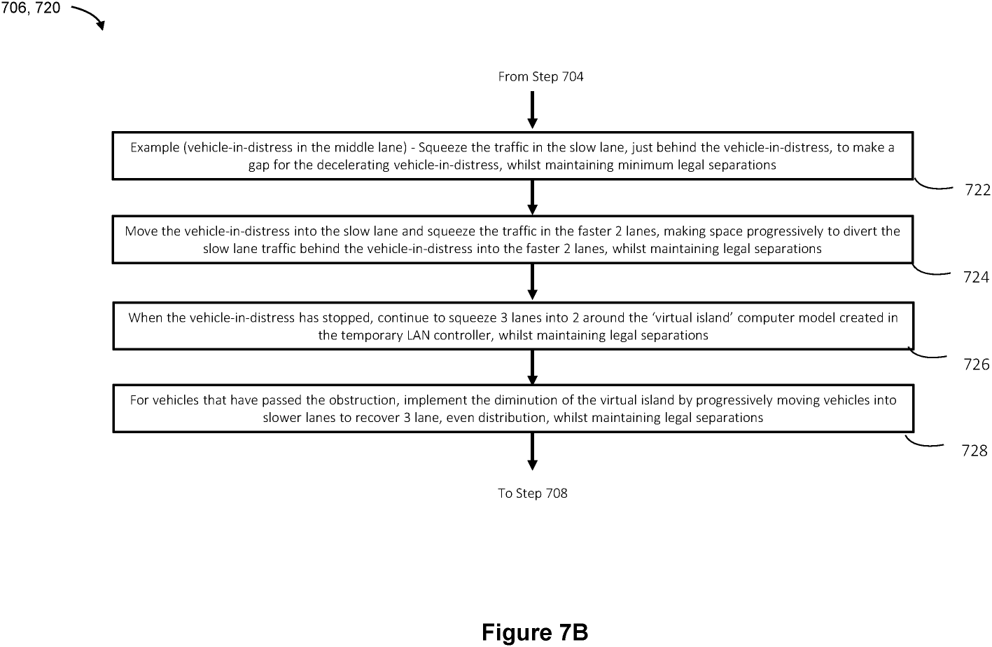

The traffic management functions of the temporary LAN then operate completely analogously to the permanent examples described above, manoeuvering by direct control or by advice to drivers the healthy vehicles in the most efficient manner around a ‘virtual traffic island’ modeled in the LAN control apparatus 20 (i.e. areas of the road which vehicles are directed to be nominated as an exclusion zone which they are unable to enter). An example of the specific functions that can be implemented in the nominated LAN control apparatus 20 is shown in the flow chart of FIG. 7A. This capability can clearly be extended to enable a moving virtual island to be created, for example around an emergency response vehicle that is manoeuvering slowly near the faulty vehicle.

FIG. 7A shows a method of operation 700 for the scenario of FIG. 6. In FIG. 7A, a tracking apparatus 10 detects, at Step 702, a vehicle behaving erroneously in accordance with embodiments discussed above. This may be detected by a tracking apparatus 10 noting a vehicle is slowing unexpectedly. The method then proceeds to assign, at Step 704, the closest vehicle tracking apparatus to the vehicle in question as the LAN control apparatus 20. In some examples, there will already be a preassigned LAN control apparatus 20. In these examples, the assignment step is not required and instead, a transmission is sent to the preassigned LAN control apparatus 20 indicating the status and kinematic parameters of the distressed vehicle. Following this, the LAN control apparatus 20 (using the Obstruction / Hazard Detection Processing Engine 216) determines at Step 706 at least a viable and preferably an optimal placement strategy comprising a set of manoeuvres for a plurality of vehicles within the field of view of the LAN in order to safely place both the distressed vehicle (where possible) and to manoeuvre other vehicles around the distressed vehicle. Such manoeuvres may include changes in positioning and velocity of the vehicles. In the case of the distressed vehicle, the manoeuvres may comprise placing the vehicle in an area which causes minimal disruption, such as the hard shoulder of a motorway. In some instances, this may not be possible, and the Obstruction / Hazard Detection Processing Engine 216 is configured to calculate a set of manoeuvres for other vehicles noting the limitations placed on the distressed vehicle. A range of possible techniques may be used by the processor 204, associated software program, and memory 206 of the LAN control apparatus 20, from simple deterministic calculations to artificial intelligence algorithms. Once this strategy has been established, the method proceeds to form, at Step 708, one or more control signals based on the determined strategy. The one or more control signals will typically of a form which may be enacted by the vehicles they relate to. It is to be appreciated that typically, in order to formulate an appropriate strategy, it is necessary for a plurality of vehicles to perform a set of manoeuvres (e.g. to create a space for the requesting vehicle to enter into). As such, at Step 708, typically multiple control signals are generated, each intended for a particular recipient vehicle and comprise the particular set of manoeuvres that this particular vehicle needs to enact. Following the generation of the one or more control signals, the method then proceeds to transmit, at Step 710, the generated control signals to the associated vehicles. The transmission may occur directly from the LAN control apparatus 20 to the vehicles, or may occur via one or more of the vehicle tracking apparatuses 10. The vehicles are then manoeuvred to effect the strategy. It is to be appreciated that the strategy may have conditional aspects to it. For example, once instructions are sent to vehicles to create a space in a particular lane, the timing on when the instruction for other vehicles to also manoeuvre is sent, can be made dependent on the LAN sensing that the space has indeed been created. This provides an additional safety feature for the system and also enables the system to be used with semi-autonomous vehicles. The method then proceeds to end at Step 712.

A detailed example 720 of a vehicle in distress manoeuvre is now described with reference to FIG. 7B. It is envisaged that such an example may be utilised as part of the formulation in Step 706, following the request received at Step 704. At Step 722, the manoeuvres may squeeze traffic in a designated slow lane just behind the vehicle in distress, to make a gap for the decelerating vehicle-in-distress, whilst maintaining minimum legal separations. At Step 724, the vehicle in distress is moved into the slow lane, and traffic in the faster two lanes is squeezed. This makes space to progressively divert the slow lane traffic behind the vehicle in distress into the faster two lanes, whilst maintaining legal separations. Following this, at Step 726, when the vehicle-in-distress has been stopped, the three lanes continue to be squeezed into two around the ‘virtual island’ computer model created in the LAN control apparatus processor 204, whilst maintaining legal separations. The example 720 then proceeds to Step 728, where for vehicles that have passed the obstruction, the diminution of the virtual island is enacted by progressively moving vehicles into slower lanes to recover three lane, even distribution, whilst maintaining legal separations. Once the example is completed, the method 720 proceeds to Step 708 of FIG. 7A where the control signals are generated.

It is to be appreciated that in this example and examples provided above in which control signals are generated, the methods given may be both discrete or continuous. In some examples, it may only be necessary to generate a single set of control signals, in others, a continuous set of control signals may need to be generated, particularly where vehicles are constantly entering and leaving the monitored geographic area, or where the status of a vehicle in distress is changing. In such cases, the described methods may be configured to repeat until it is determined that no more control signals are required to be generated.

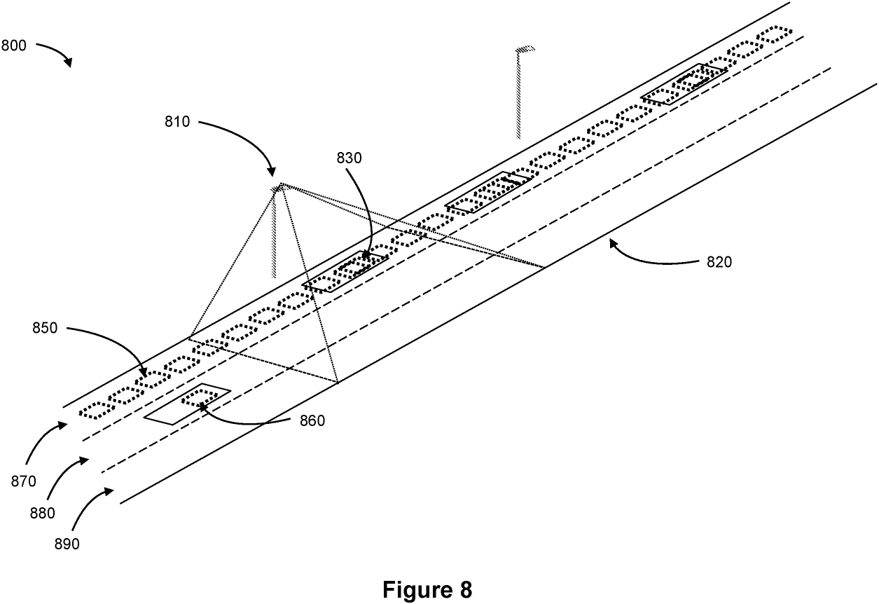

The current embodiments also provide closely related systems and methods that enable electric or hybrid electric powered vehicles, ground-based, water-borne and airborne, to be connected to sources of electric power either to provide motive power directly or to re-charge batteries ‘on-the-go’ through conductive or inductive electric power transfer in a more efficient manner than any pre-existing systems or methods. FIG. 8 shows just one example where a dynamic inductive power transfer system comprising coils 850 in one lane 870 of a road 820 and coils in the vehicle 860 enable electrical power to be transferred whilst the vehicle is in motion. This requires:
a. vehicles requiring charging to be selected and manoeuvred into the powered lane so that the powered lane utilization can be maximized and hence the extent of expensive powered lanes minimized, and
b. very precise continuous lateral alignment of the vehicle 820 with the road infrastructure coils 850 and possibly very precisely timed energizing of each road coil 850 as the vehicle passes over and is being dynamically charged so that the charging is as efficient as possible, and the vehicle needs to spend the minimum time possible in the powered lane 870.

The current embodiments provide the capability for a) in a manner analogous to that described above for the highway/freeway/motorway junction and, additionally, provides the guidance precision and timing required for b). The current embodiments also provide these capabilities for other forms of electrical power transfer - for example conductive transfer from rails in or on the road to components such as brushes or skates in the vehicle that must be continuously aligned with the rails or as another example where overhead power lines make power available and a vehicle’s power transfer system (such as a catenary pair) must be continuously aligned.

It is to be appreciated that aircraft can also be recharged using the present system. In this instance, an electrical charging ground based or water-borne vehicle can be instructed by the system to move to a particular lane and maintain its relative position within the lane (lateral position). Similarly, the speed of the vehicle can be controlled to also be constant. Thereafter, a small aircraft (such as a drone) could be guided by sending it instruction signals to landing on the electrical charging vehicle and recharging its batteries for a period of time before launching off the ground based or water-borne vehicle back into its air corridor.

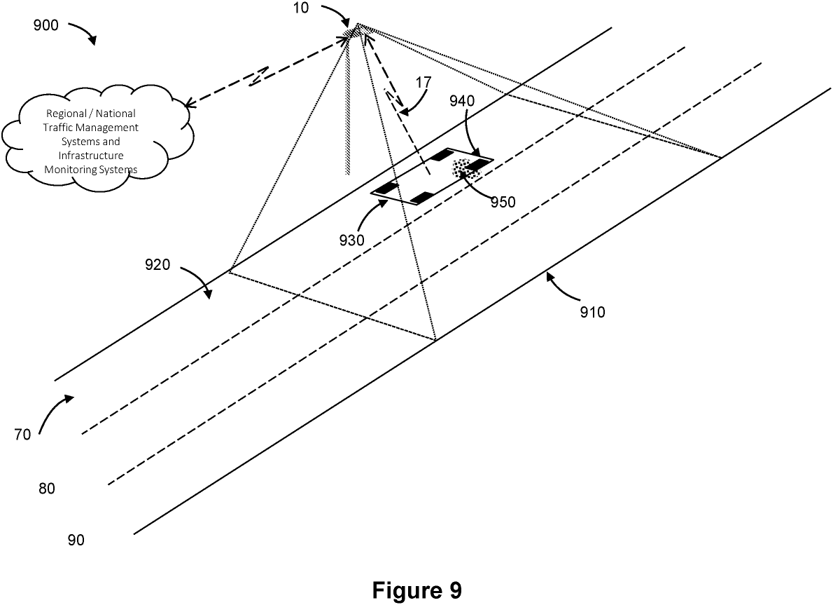

As a final capability the current embodiments also provide for vehicles on roads to be used as a means of measuring the condition of road surfaces in a much more effective manner than any previous approach. FIG. 9 again shows a short section of 3-lane carriageway 900 on a freeway/highway/motorway. Lane 70 has a pothole 950 and the front, off-side wheel 940 of vehicle 930 is just passing over the pot-hole. It is assumed that the vehicle 930 is fitted with equipment that can detect the pothole as the wheel passes over it. Such an equipment fit is straightforward and, as two illustrative examples, may comprise vibration or impact sensors fitted to the vehicle body or suspension or may comprise deflection monitors fitted to one or more component of the suspension system of the wheel 940.

The data generated by the equipment, indicating at least the presence and possibly the severity of the road defect, can then be transmitted by the communication system linking the vehicle to the vehicle tracking equipment. This transmission has the low latency characteristic of the current embodiments overall and hence can be combined with or associated with the precise location of the vehicle generated by the tracking equipment at the time the road defect data is generated. In this way, the precise position of the road defect (to an accuracy of a few centimeters) can be determined by the tracking equipment.

This very precise and current road condition data can be transmitted onwards, either via the local area networks described above or via the various other means such as wired or wireless communications channels or satellite communications channels, to local, regional or national road condition monitoring systems. Furthermore, the repeated passage of traffic over the road defects provides confirmatory data and also enables the defect sizes and defect growth rates to be monitored. This greatly increases the maintainability of the infrastructure. In addition, in order to reduce the growth rates of the road defects, the tracking equipment can provide advisory or control signals to vehicles as they approach the defects that enables the vehicles to steer precisely and avoid the defects, whilst maintaining safe lateral separations with other road vehicles. Finally, this road condition monitoring capability can also extend to the detection of foreign objects on the road that can be detected by the equipment on the vehicles, allowing vehicles to avoid them and alerting maintenance services to their presence triggering removal action.

Having described several exemplary embodiments of the present embodiments and the implementation of different functions of the device in detail, it is to be appreciated that the skilled addressee will readily be able to adapt the basic configuration of the system to carry out described functionality without requiring detailed explanation of how this would be achieved. Therefore, in the present specification, several functions of the system have been described in different places without an explanation of the required detailed implementation as this not necessary given the abilities of the skilled addressee to implement functionality into the system.

Furthermore, it will be understood that features, advantages, and functionality of the different embodiments described herein may be combined where context allows.

1. A vehicle management system for controlling movement of a plurality of vehicles along a pathway at a current geographic location of a transport network, the vehicle management system comprising:
a receiver configured to:
receive sensed kinematic parameters of the plurality of vehicles at the current geographic location; and
receive event data relating to the occurrence of an event concerning the movement of the plurality of vehicles;
a processor configured to:
determine required kinematic parameters of at least one of the plurality of vehicles in order to respond to the event;
determine, based on the sensed kinematic parameters and the required kinematic parameters, one or more actions to be taken by the one or more of the plurality of vehicles which enable the required kinematic parameters to be achieved; and
generate one or more instruction signals for the one or more vehicles to instruct the one or more actions to be taken; and
a transmitter configured to transmit the one or more instruction signals to the respective one or more vehicles to enable the one or more actions to be implemented.

2. A vehicle management system of claim 1, wherein the event data comprises a maneuver request from a vehicle, a threshold for a vehicle movement parameter (for example traffic density), or an alert regarding an emergency event.

3. A vehicle management system of claim 2, wherein the processor is configured to determine a current position of an event-related vehicle.

4. A vehicle management system of claim 3, wherein the processor is configured to generate actions to increase the speed of a vehicle of the plurality of vehicles which is downstream of the current position of the event-related vehicle to create a gap between adjacent vehicles of the plurality of vehicles.

5. A vehicle management system of claim 3, wherein the processor is configured to generate actions to decrease the speed of a vehicle of the plurality of vehicles which is upstream of the current position of the event-related vehicle to create a gap between adjacent vehicles of the plurality of vehicles.

6. A vehicle management system of claim 4, wherein the processor is configured to generate an action to move the event-related vehicle into the gap.

7. A vehicle management system of claim 6, wherein the processor is configured to generate one or more actions to regularise separations between adjacent vehicles of the plurality of vehicles following movement of the event-related vehicle into the gap.

8. A vehicle management system of claim 2, wherein the pathway comprises a plurality of lanes and the processor is configured to generate actions to:
create a gap in an adjacent lane to a current lane of the event-related vehicle or hazard by decreasing the speed of a vehicle of the plurality of vehicles which is upstream of the current position of the event-related vehicle or hazard and/or increasing the speed of a vehicle of the plurality of vehicles which is downstream of the current position of the event-related vehicle or hazard; and
move a vehicle of the plurality of vehicles, upstream of and in the same lane as the event-related vehicle or hazard, into the gap.

9. A vehicle management system of claim 8, wherein the processor is configured to generate actions to:
move a vehicle downstream of and in an adjacent lane as the event-related vehicle or hazard into the same lane as the event-related vehicle or hazard.

10. A vehicle management system of claim 2, wherein the processor is configured to generate actions to alter the speed of a vehicle of the plurality of vehicles to minimise a distance between adjacent vehicles to a predetermined minimum thereby increasing a traffic density parameter.

11. A vehicle management system of claim 1, wherein the processor is configured to generate actions to move a vehicle of the plurality of vehicles to a location within the pathway aligned with inductive or conductive charging apparatus and to maintain the alignment of the vehicle with the inductive or conductive charging apparatus for a period of time to enable inductive or conductive charging of the vehicle to be carried out whilst the vehicle is moving along the pathway.

12. A vehicle management system of claim 1, wherein the processor is configured to generate actions to:
maintain a docking vehicle of the plurality of vehicles at a constant speed and a constant location relative to the pathway; and
guide another vehicle to dock with the docking vehicle whilst the docking vehicle is moving along the pathway.

13. A vehicle management system of claim 1, wherein the receiver is configured to:
receive incident data from a vehicle of the plurality of vehicles, the incident data relating to a geographic location of an incident sensed by the vehicle; and
the processor is configured to store the geographic location of the incident in a data store.

14. A vehicle management system of claim 13, wherein the transmitter is configured to transmit the incident data to an infrastructure monitoring system.

15. A vehicle management system of claim 13, wherein the incident data relates to the physical condition of the pathway sensed by the vehicle at a plurality of specific geographical locations.

16. A vehicle management system of claim 1, wherein the receiver is configured to receive further sensed parameters from another system communicatively coupled to the vehicle management system and the processor is configured to determine the required parameters from the further sensed parameters.

17. A vehicle management system of claim 16, wherein the further sensed parameters relate to an event occurring at a location towards which the plurality of vehicles is travelling, downstream of the current geographic location.

18. A vehicle management system of claim 16, wherein the further sensed parameters relate to a desired traffic density or flow rate event.

19. A vehicle management system of claim 1, wherein the receiver is configured to receive the sensed kinematic parameters from one or more vehicle tracking apparatuses provided about the pathway.

20. A vehicle management system of claim 1, wherein the transmitter is configured to transmit the one or more instruction signals to the one or more of the plurality of vehicles via one or more vehicle tracking apparatuses provided about the pathway.

21. A vehicle management system of claim 1, wherein one of the plurality of vehicles comprises an autonomous or semi-autonomous vehicle and the instruction signal comprises a control signal configured to control the movement of the autonomous or semi-autonomous vehicle.

22. A vehicle management system of claim 1, further comprising one or more vehicle tracking apparatuses provided about the pathway at the geographical location, the vehicle tracking apparatus having a positional measurement accuracy to within 10 cm with a dynamic latency of less than 20 milliseconds.

23. A vehicle management system of claim 22, wherein the one or more vehicle tracking apparatuses has a field of view directed to the pathway and is configured to sense the position of each of the plurality of vehicles and determine the sensed kinematic data from the sensed positions over a time period.

24. A vehicle management system of claim 22, wherein the one or more vehicle tracking apparatus comprises a plurality of vehicle tracking apparatuses communicatively connected together in a local area network configuration.

25. A vehicle management system of claim 22, wherein the one or more vehicle tracking apparatus comprises an infra-red radiation sensor.

26. A vehicle management system of claim 25, wherein the one or more vehicle tracking apparatus comprises an infra-red radiation emitter.

27. A vehicle management system of claim 22, wherein the one or more vehicle tracking apparatus is configured to provide the one or more instruction signals to the one or more of the plurality of vehicles.

28. A vehicle management system of claim 22, wherein the one or more vehicle tracking apparatus is configured to track the movement of one or more airborne, waterborne or land vehicles.

29. A vehicle management system of claim 1, wherein the processor includes an event recognition engine for determining the type of event which the event data relates to and one or more event response processing engines for determining the one or more actions to be taken.

30. A vehicle management system of claim 29, wherein the one or more event processing engines comprises a lane change request processing engine which is configured to generate actions to enable a requesting vehicle of the plurality of vehicles in a current lane of a multi-lane pathway to move into a different, desired lane of the multi-lane pathway, the lane change processing engine being configured to:
determine a current position of the requesting vehicle requesting a change to the desired lane of the multi-lane pathway;
generate actions to increase the speed of a vehicle of the plurality of vehicles in the desired lane which is downstream of the current position of the requesting vehicle and/or decrease the speed of a vehicle of the plurality of vehicles in the desired lane which is upstream of the current position of the requesting vehicle, to enable a gap to be created within the desired lane between adjacent moving vehicles of the plurality of vehicles; and
to generate an action to move the requesting vehicle into the gap.

31. A vehicle management system of claim 29, wherein the one or more event processing engines comprises an exit/entry request processing engine which is configured to generate actions to enable a requesting vehicle of the plurality of vehicles to move from a current lane of the pathway to an exit lane, the exit/entry request processing engine being configured to:
determine a current position of the requesting vehicle;
generate an action to increase the speed of a vehicle of the plurality of vehicles in the exit lane which is downstream of the current position of the requesting vehicle and/or decrease the speed of a vehicle of the plurality of vehicles in the exit lane which is upstream of the current position of the requesting vehicle, to enable a gap to be created within the exit lane between adjacent vehicles of the plurality of vehicles in the exit lane; and
generate an action to move the requesting vehicle into the gap.

32. A vehicle management system of claim 29, wherein the one or more event processing engines comprises an exit/entry request processing engine which is configured to generate actions to enable a requesting vehicle of the plurality of vehicles to move from an entry lane of the pathway into a desired lane, the exit/entry request processing engine being configured to:
determine a current position of a requesting vehicle requesting a change from an entry lane into the desired lane of a multi-lane pathway;
generate actions to increase the speed of a vehicle of the plurality of vehicles in the desired lane which is downstream of the current position of the requesting vehicle and/or decrease the speed of a vehicle of the plurality of vehicles which is upstream of the current position of the requesting vehicle, to enable a gap to be created within the desired lane between adjacent vehicles of the plurality of vehicles; and
generate an action to move the requesting vehicle into the gap.

33. A vehicle management system of claim 31, wherein the pathway comprises a multi-lane pathway and the exit/entry request processing engine is configured to generate actions to:
enable the requesting vehicle of the plurality of vehicles to move across a lane of the multi-lane pathway which is adjacent to the current lane by increasing the speed of a vehicle of the plurality of vehicles in the adjacent lane which is downstream of the current position of the requesting vehicle and/or decrease the speed of a vehicle of the plurality of vehicles which is upstream of the current position of the requesting vehicle, to enable an adjacent lane gap to be created within the adjacent lane between adjacent moving vehicles of the plurality of vehicles; and
move the requesting vehicle into the adjacent lane gap.

34. A vehicle management system of claim 29, wherein the one or more event processing engines comprises an obstruction/hazard detection processing engine which is configured to identify a location of obstruction/hazard in the pathway; and the obstruction/hazard detection processing engine comprises an exclusion zone generator configured to determine a strategy to enable a vehicle upstream of the location of the obstruction/hazard to avoid the obstruction/hazard and to generate one or more actions to execute the strategy.

35. A vehicle management system of claim 34, wherein the exclusion zone generator is configured to generate actions to:
create a gap in adjacent lane by reducing the speed of a vehicle upstream of the location of the obstruction/hazard; and
move a vehicle in the same lane as the obstruction/hazard into the gap in the adjacent lane thereby creating a virtual island around the obstruction/hazard.

36. A vehicle management system of claim 29, wherein the one or more event processing engines comprises a traffic density/flow rate management engine which is configured to increase a traffic density/flow rate parameter of the plurality of vehicles by generating actions to alter the speed of one or more vehicles of the plurality of vehicles to minimise a distance between adjacent vehicles to a predetermined minimum.

37. A method of controlling movement of a plurality of vehicles along a pathway at a current geographic location of a transport network, the method comprising:
receiving sensed kinematic parameters of the plurality of vehicles at the current geographic location;
receiving event data relating to the occurrence of an event concerning the movement of the plurality of vehicles,
determining required kinematic parameters of at least one of the plurality of vehicles in order to respond to the event;
determining, based on the sensed kinematic parameters and the required kinematic parameters, one or more actions to be taken by the one or more of the plurality of vehicles which enable the required kinematic parameters to be achieved;
generating one or more instruction signals for the one or more vehicles to instruct the one or more actions to be taken; and
transmitting the one or more instruction signals to the respective one or more vehicles to enable the one or more actions to be implemented.

38. A computer-readable storage medium comprising instructions which, when executed by a computer, cause the computer to carry out the steps of the method of claim 37.
